(19) United States
(12) Patent Application Publication
(10) Pub. No.: US 2014/0081968 A1
(43) Pub. Date: Mar. 20, 2014

(54) Methods, Systems, and Program Products for Automatically Managing Tagging of a Resource

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/622,370

(22) Filed: Sep. 19, 2012

(51) Int. Cl. G06F 17/30

(52) U.S. Cl. 707/736; 707/E17.009

(57) ABSTRACT

Methods and systems are described for automatically managing tagging of a resource. In one aspect, a first matched tag is identified that identifies a first tag and a first tagging criterion, wherein whether the first tagging criterion is met for a first resource is based on a first attribute of the first resource. A change to the first attribute is detected. Based on the change, whether the first tagging criterion is met for the first resource is determined. The first resource is tagged with the first tag, automatically in response to determining that the first criterion is met.

### RELATED APPLICATIONS

This application is related to the following commonly owned U.S. patent applications: application Ser. No. 13/622,366 (Docket No DRV0002) filed on Sep. 19, 2012, entitled “Methods, Systems, and Program Products for Tagging a Resource”;

Application Ser. No. 13/622,367 (Docket No DRV0005) filed on Sep. 19, 2012, entitled “Methods, Systems, and Program Products for Distinguishing Tags for a Resource”;

Application Ser. No. 13/622,372 (Docket No DRV0007) filed on Sep. 19, 2012, entitled “Methods, Systems, and Program Products for Navigating Tagging Contexts”;

Application Ser. No. 13/622,371 (Docket No DRV0009) filed on Sep. 19, 2012, entitled “Methods, Systems, and Program Products for Locating Tagged Resources in a Resource Scope”; and

Application Ser. No. 13/622,368 (Docket No DRV0021) filed on Sep. 19, 2012, entitled “Methods, Systems, and Program Products for Identifying a Matched Tag Set”.

### BACKGROUND

Tagging has become a common way to allow users to categorize and/or otherwise create relationships between resources on the Web. Resources, such as images, video, audio, documents, and other web content are tagged every day. One of the disadvantages of tagging is that it is user intensive. Each tag associated with the many resources on the Web is added by a user. Tags are static in that once a resource is tagged, the tag remains even though the resource and/or some attribute Another disadvantage is that tagging is static in that tags for a resource do not change even if the resource changes, unless a user changes the tags. Not only is this inefficient, it is a source or errors and/or inconsistencies in tags. For example, this user intensive effort increases the number tags that use alternate spellings, which are typically treated as different tags. Misspellings lead to further errors. Additionally, when a resource is added or created it is not tagged. It may take quite some time before the set of tags associated with a new resource becomes stable. Still further, this user intensive effort leads to the loss of many tags, as users choose not to make the effort to tag resources.

Accordingly, there exists a need for methods, systems, and computer program products for automatically managing tagging of a resource.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for automatically managing tagging of a resource. In one aspect, the method includes identifying a first matched tag that identifies a first tag and a first tagging criterion, wherein whether the first tagging criterion is met for a first resource is based on a first attribute of the first resource. The method further includes detecting a change to the first attribute. The method still further includes determining, based on the change, whether the first tagging criterion is met for the first resource. The method additionally includes tagging the first resource with the first tag, automatically in response to determining that the first criterion is met. The method also includes removing a tagging of the first resource with the first tag, automatically in response determining that the first tagging criterion is not met. Performing at least one the preceding actions comprising the method includes execution of an instruction by a processor.

Also, a system for automatically managing tagging of a resource is described that includes one or more processors and logic encoded in one or more tangible media for execution by the one or more processors that when executed is operable for identifying a first matched tag that identifies a first tag and a first tagging criterion, wherein whether the first tagging criterion is met for a first resource is based on a first attribute of the first resource; detecting a change to the first attribute; determining, based on the change, whether the first tagging criterion is met for the first resource; tagging the first resource with the first tag, automatically in response to determining that the first criterion is met; and removing a tagging of the first resource with the first tag, automatically in response determining that the first tagging criterion is not met.

Further, a system for automatically managing tagging of a resource is described. The system includes a tag director component for identifying a first matched tag that identifies a first tag and a first tagging criterion, wherein whether the first tagging criterion is met for a first resource is based on a first attribute of the first resource. The system further includes a resource access component for detecting a change to the first attribute. The system still further includes a criterion match component for determining, based on the change, whether the first tagging criterion is met for the first resource. The system additionally includes a tagging for tagging the first resource with the first tag, automatically in response to determining that the first criterion is met. The system also includes a tagging for removing a tagging of the first resource with the first tag, automatically in response determining that the first tagging criterion is not met. The system also includes a processor, wherein at least one of the tag director component, the resource access component, and the tagging component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for automatically managing tagging of a resource according to an aspect of the subject matter described herein;

FIG. 3 is a block diagram illustrating an arrangement of components for automatically managing tagging of a resource according to another aspect of the subject matter described herein;

FIG. 4A is a block diagram illustrating an arrangement of components for automatically managing tagging of a resource according to another aspect of the subject matter described herein;

FIG. 4B is a block diagram illustrating an arrangement of components for automatically managing tagging of a resource according to another aspect of the subject matter described herein;

FIG. 4C is a block diagram illustrating an arrangement of components for automatically managing tagging of a resource according to another aspect of the subject matter described herein;

FIG. 4D is a block diagram illustrating an arrangement of components for automatically managing tagging of a resource according to another aspect of the subject matter described herein;

FIG. 5 is a network diagram illustrating a system for automatically managing tagging of a resource according to another aspect of the subject matter described herein;

FIG. 6A is a diagram illustrating a user interface presented via a display according to another aspect of the subject matter described herein; and

FIG. 6B is a diagram illustrating a user interface presented via a display according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present specification, including definitions, will control. In addition, the materials, methods, and examples are illustrative only and not intended to be limiting.

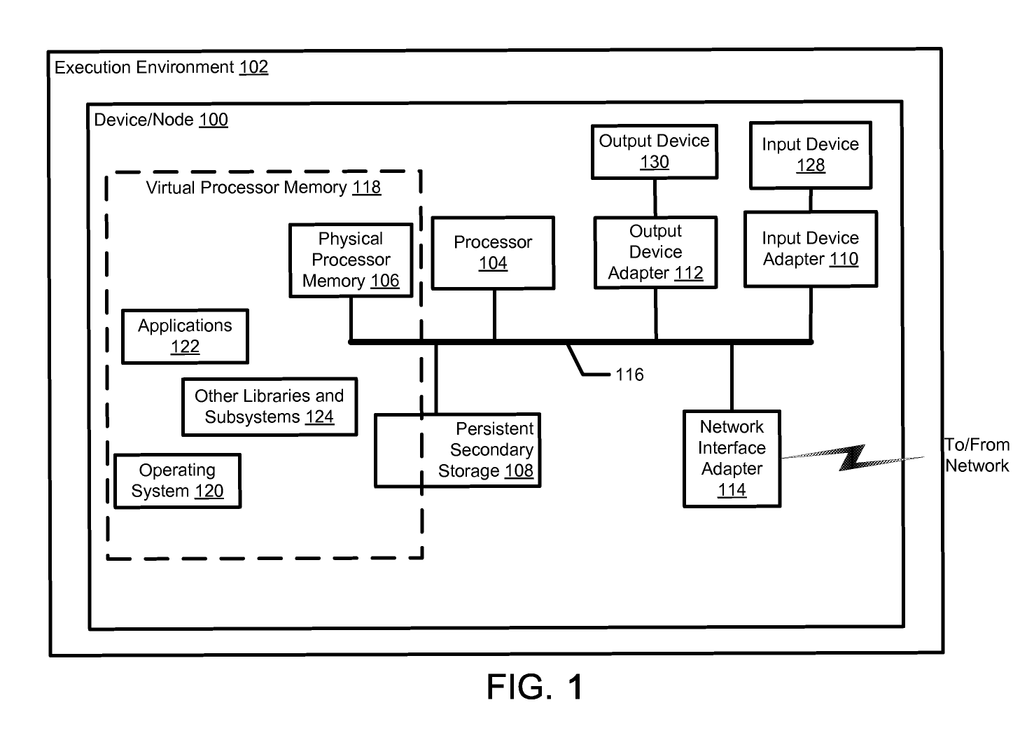

An exemplary device included in an execution environment that may be configured according to the subject matter is illustrated in FIG. 1. An “execution environment”, as used herein, is an arrangement of hardware and, in some aspects, software that may be further configured to include and/or otherwise host an arrangement of components for performing a method of the subject matter described herein. An execution environment includes and/or is otherwise provided by one or more devices. The execution environment is said to be the execution environment of the device and/or devices. An execution environment may be and/or may include a virtual execution environment including software components operating in a host execution environment. Exemplary devices included in and/or otherwise providing suitable execution environments for configuring according to the subject matter include personal computers, notebook computers, tablet computers, servers, portable electronic devices, handheld electronic devices, mobile devices, multiprocessor devices, distributed systems, consumer electronic devices, routers, communication servers, and/or any other suitable devices. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter for presenting information to a user; a network interface component, illustrated by a network interface adapter 114, for communicating via a network such as a LAN and/or WAN; and a communication mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access machine code instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of a machine code instruction and/or may be identified by a register or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is referred to as a virtual processor memory or virtual memory. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated tangible computer readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space are stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein may refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

An order of visual outputs in a depth dimension is herein referred to as a “Z-order”. The term “Z-value” as used herein refers to a location in a Z-order. A Z-order specifies the front-to-back and/or back-to-front ordering of visual outputs in a presentation space with respect to a Z-axis. In one aspect, a visual output with a higher Z-value than another visual output may be defined to be on top of or closer to the front than the other visual output. In another aspect, a visual output with a lower Z-value than another visual output may be defined to be on top of or closer to the front than the other visual output.

A “user interface (UI) element handler” component, as the term is used herein, includes a component of configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a user agent from a remote application provider may include HTML, ECMAScript, and/or byte code for presenting one or more UI elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. As used herein, the terms “application”, and “service” may be realized in one or more executables and/or in one or more hardware components. The terms are used interchangeably herein.

As used herein, an “addressable entity” is program of a portion thereof, specifiable in programming language in source code. An addressable entity is addressable in a program component translated for a compatible execution environment from the source code. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate languages for processing by an interpreter, compiler, linker, loader, and/or other analogous tool.

As used herein, the term “network protocol” refers to a formal set of rules, conventions and data structures that governs how computers and other network devices exchange information over a network. The rules, conventions, and data structures are said to be specified or defined in a specification and/or schema.

The term “network path” as used herein refers to a sequence of nodes in a network that are communicatively coupled for transmitting data in one or more data units of a specified network protocol between a pair of nodes in the network.

A “data unit”, as the term is used herein, is a data entity specified according to a network protocol for transmitting data contained in and/or otherwise identified by the data entity. A data unit is transmitted between a pair of nodes in a network path to send the data in and/or otherwise identified by the data unit from a source node to a destination node that includes a protocol endpoint of the network protocol. A network protocol explicitly and/or implicitly specifies and/or otherwise identifies a schema that defines one or more of a format for a valid data unit and a vocabulary for content of a valid data unit. One example of a data unit is an Internet Protocol (IP) packet. The Internet Protocol defines a format for an IP packet that defines a header for identifying a destination address that identifies a destination node and a payload portion for including a representation of data to be delivered to the identified destination node. The terms “data unit”, “data packet”, and “packet” are used interchangeably herein. One or more data units of a first network protocol may transmit a message of second network protocol. For example, one or more data units of the IP protocol may include a TCP message. In another example, one or more TCP data units may transmit an HTTP message.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units for transmitting to a next node in the network path. Portions of data received in several data units may be combined into a single data unit for transmitting by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the protocol. For example 192.168.1.1 is an IP protocol address represented in a human readable format that may be included in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

A node in a pair of nodes in a network path at one end of the sequence of nodes in the network path and/or the other end is referred to herein as a “path end node”. Note that a node may have two NICs with one NIC at each end of a network path. A network path may be included as a portion of another network path that communicatively couples a same pair of nodes. Data may be transmitted via the sequence of nodes in a network path between path end nodes communicatively coupled via the network path. Data may be transmitted in one or both directions depending on an ordering of the nodes in the sequence.

The term “hop” as used herein refers to a pair of consecutive nodes in a network path for transmitting, via a network protocol, data sent from a source node to a destination node. A “hop path” is thus a sequence of hops in a network that respectively include a sequence of pairs of consecutive nodes included in transmitting data from a first path end node of the network path to a second path end node of the network path.

The term “path-based protocol address” as used herein refers to a protocol address for a network protocol that includes a plurality of path segment identifiers that identify portions of a specific network path identified by the path-based protocol address. A “node-based protocol address” is a path-based protocol address that includes a plurality of node identifiers that identify a sequence of nodes in a network path. A “network-interface-based protocol address” is a path-based protocol address that includes a plurality of network interface identifiers that identify a sequence of network interfaces in a network path. A “NIC-based protocol address” is a type of network-interface-based protocol address that includes a plurality of identifiers that identify a sequence of network interface components. A “hop-based protocol address” is a type path-based protocol address since a hop is a type of network path.

Given the above definitions, note that the terms “network path” and “hop” may be defined in terms of network interfaces. A “network path” and a “hop path” include a sequence of network interfaces in a network that are included in transmitting data between a pair of path end nodes in the network. A “hop” refers to at least part of a network path that includes a pair of consecutive network interfaces in a sequence of network interfaces in a network path. A “network path” is thus a sequence of hops in a network that respectively include a sequence of pairs of consecutive network interfaces included in transmitting data from a first path end node of the network path to a second path end node of the network path.

The term “network topology” as used herein refers to a representation of protocol endpoints and/or nodes in a network, and representations of hops representing communicative couplings between and/or among the protocol endpoints and/or nodes in the network. A network may have different network topologies with respect to different network protocols. A network topology may represent physical communicative couplings between nodes in the network. A network topology may represent logical couplings between protocol endpoints and/or nodes of a particular network protocol or a particular type of network protocol.

The domain name system (DNS) of the Internet operates based on an application layer protocol defined by the DNS. The nodes in the DNS are communicatively coupled via the DNS protocol and may be represented by a logical network topology. A DNS system includes nodes connected via the DNS protocol and thus has a network topology defined by nodes that include protocol endpoints of the DNS protocol. In still another example, a token-ring network has a circular topology at the link layer, but may have a star topology at the physical layer.

As used herein, an “entity-specific address space” refers to an address space defined for a specific entity where the addresses in the address space operate as identifiers in the context of the entity. An address from an entity-specific address space is referred to herein as an “entity-specific address”. An address is “entity-specific” in that what it identifies is based on the entity to which it is specific. Another address having the same form and content may identify a different entity when in an address space specific to another entity. Addresses in an entity-specific address space operate as identifiers in the context of an entity to which they are “specific” as defined by the specific association of the address space and the entity. Without knowledge of the entity to which an entity-specific address space is specific, what an address in the entity-specific address space identifies is indeterminate. The terms “entity-specific address” and “entity-specific identifier” are used interchangeably herein. An entity-specific address may identify an entity included in the entity to which the address is specific or may identify an entity external to the entity to which the address is specific. The fact that an address is entity-specific does not define a scope for the address.

A portion of a network is a type of entity. A type of entity-specific address space described herein is a scope-specific address space. As used herein, a “scope-specific address space”, specific to a particular region of a network, is an address space defined for the particular network region, where an address in the scope-specific protocol address operates as identifier, according to a network protocol, of a protocol endpoint in a node outside of the particular region when processed in the context of a node in the particular region. The region is indicated by the span of an indicated scope. The terms “region” and “zone” are used interchangeably herein. An address from a scope-specific address space is referred to herein as a “scope-specific protocol address”. An address is “scope-specific” in that what protocol endpoint it identifies depends on the region to which it is specific. Another address having the exact same form and content may identify a different protocol endpoint when in an address space that is specific to another region. A protocol address in a scope-specific address space serves as an identifier in the context of a node in a region to which the scope-specific address space is “specific” as defined by an association of the address space and the region indicated by the scope. Without knowledge of the particular region to which a scope-specific address space is specific, what a scope-specific protocol address in the scope-specific address space identifies is indeterminate. The terms “scope-specific protocol address” and “scope-specific protocol identifier” are used interchangeably herein. Types of scope-specific address spaces indicating exemplary spans include site-specific, LAN-specific, subnet-specific, city-specific, business-specific, and node-specific.

For a network protocol, an address in a scope-specific address space serves as an identifier of a protocol endpoint in a node. Data may be received via the protocol endpoint from a network via one or more network interfaces that operatively couple the node to the network. Data may be sent via the protocol endpoint for transmitting over the network via the one or more network interfaces in the node. Since a protocol endpoint of a network protocol is included in a node and is accessible via a network via a network interface, a protocol address identifying the protocol endpoint also identifies the node and identifies a network interface of the node.

As used herein, a “node-specific address space” is a scope-specific address space defined for a specific node in a network, where the addresses in the node-specific address space operate as identifiers of nodes and/or network interfaces in the network when processed in the context of the specific node. An address from a node-specific address space is referred to herein as a “node-specific address”. An address is “node-specific” in that what it identifies depends on the node to which is defined as specific. Another address having the exact same form and content may identify a different node when in an address space specific to another node. Addresses in a node-specific address space operate as identifiers in the context of a node to which they are “specific” as defined by the specific association of the address space and the node. Without knowledge of the node to which a node-specific address space is specific, addresses in the node-specific address space are indeterminate. The terms “node-specific address” and “node-specific identifier” are used interchangeably herein. A node-specific address space is a type of scope-specific address space.

The term “node” is defined above. Note that an identifier of a network interface in a network also identifies a node that includes the network interface. Thus, a network interface-specific address is also a node-specific address. Network interfaces in a node may have their own respective network interface-specific address spaces that are also node-specific. The network interface-specific address spaces may be combined to form a node-specific address space and/or may be managed as separate address spaces. The adjectives “node-specific” and “network interface-specific” may be used interchangeably.

A scope-specific identifier differs from a scoped address as described in “Request for Comments” (RFC) document RFC 4007 by S. Deering, et al, titled “IPv6 Scoped Address Architecture”, published by the IETF in December, 2006 and further described in application Ser. No. 11/962,285, by the present inventor, filed on 2007/12/21, entitled “Methods and Systems for Sending Information to a Zone Included in an Internet Network”. A scoped address space is shared by nodes in a given scope. While a link-local scoped address is specific to a particular node, a link-local scoped address simply identifies a network interface component local to the particular node. A loop-back internet address is specific to a node as well. Neither link-local scoped addresses nor loop-back addresses identify one node to another. As such, neither serves as a node-specific identifier as defined above.

A “scoped address” is described by RFC 3513 and RFC 4007 as an identifier that, in a particular region of a network, serves as a protocol address of a network interface and/or a node in the particular region. The extent of the particular region is referred to as the scope of the region and thus the scope within which the identifier serves as a protocol address. A particular region included within a scope as indicated by its span. A scoped address is a valid protocol address only within a particular region as indicated by the address's indicated scope. Examples of scope indicators include node-scope where identifiers are valid only to a single node in the indicated span, LAN-scope where identifiers are valid for nodes in the span of a particular LAN, and subnet-scope where identifiers are valid only for nodes in a particular subnet. RFC 3513 currently defines support for link-local scope, site-local scope, a global scope. A data unit transmitted with a scoped address should not be delivered to node that does not have a network interface in the span indicated by the scope.

“Path information” is any information that identifies a network path and/or hop path for data transmitted via one or more specified network protocols. Path information may be identified by identifying network interfaces, NICs, nodes, and/or hops included in a network path. “Address information” is any information that identifies a protocol address that, for a network protocol, identifies a protocol endpoint. Address information may identify a unicast protocol address for a network protocol. In identifying a protocol endpoint, a protocol address identifies a node and a network interface. Those skilled in the art will understand upon reading the descriptions herein that the subject matter disclosed herein is not restricted to the network protocols described and/or their corresponding OSI layers. For ease of illustration, the subject matter is described in terms of protocols that correspond to OSI layer three, also referred to as network layer protocols, in general. Particular descriptions are based on versions of the Internet Protocol (IP). Address information may identify one or more protocol addresses. Exemplary protocol addresses include IP addresses, IPX addresses, DECNet addresses, VINES Internet Protocol addresses, and Datagram Delivery Protocol (DDP) addresses.

The term “path-based address” is defined above. A “node-based address” is a path-based address where some or all of the address includes node identifiers that identify a sequence of nodes in a network path. A “network-interface-based address” is a path-based address where some or all of the address identifies includes identifiers of a network interfaces in sequence in a network path. A “NIC-based address” is a type of network-interface-based address that identifies a sequence of network interface components. A “hop-based address” is a path-based address where some or all of the address identifies one or more hops in a network path. The protocol address types defined are not mutually exclusive.

The term “metric space”, as used herein, refers to a set, as defined in mathematics, where a distance between elements of the set is defined according to a metric. Metric spaces defined in Euclidean geometry are well-known examples. Those skilled in the art of metric spaces, such as Euclidian spaces, will appreciate that a one-to-one mapping may be determined and/or otherwise identified for mapping addresses from a first coordinate space having a first origin for a metric space to addresses from a second coordinate space having a second origin in the metric space. Given a mapping rule between a first scope-specific address space and a second scope-specific address space and a mapping between the second scope-specific address space and a third scope-specific address space based on a third coordinate space identifying a third origin in the metric space, a mapping from the first coordinate space to the third coordinate space may be determined. A mapping between coordinate spaces for a metric space may be included a coordinate shift and/or a rotation, for example. The mapping may be pre-specified and accessible to the nodes in one or both address spaces. Mapping between locations in a number of different metric spaces is well-known in mathematics. For example, a top half of the surface of sphere may be mapped to a plane. Some will further appreciate that some metric spaces may be mapped to other metric spaces. Some of these mappings are one-to-one and onto.

An “interaction”, as the term is used herein, refers to any activity including a user and an object where the object is a source of sensory data detected by the user. In an interaction the user directs attention to the object. An interaction may also include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction. The term “operational component” of a device, as used herein, refers to a component included in performing an operation by the device.

Interaction information for one object may include and/or otherwise identify interaction information for another object. For example, a motion detector may detect user's head turn in the direction of a display of a portable electronic device. Interaction information identifying the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

The term “attention information” as used herein refers to information that identifies an attention output and/or that includes an indication to present an attention output. Attention information may identify and/or may include presentation information that includes a representation of an attention output, in one aspect. In another aspect, attention output may include a request and/or one or more instructions for processing by a processor to present an attention output. The aspects described serve merely as examples based on the definition of attention information, and do not provide an exhaustive list of suitable forms and content of attention information.

As used herein the term “attention criterion” refers to a criterion that when met is defined as indicating that interaction between a user and an object is or maybe inadequate at a particular time and/or during a particular time period. In other words, the user is not directing adequate attention to the object.

As used herein, the term “tag” refers to a character string, which may include one or more words, which may be associated with a resource to create an association between the resource and another resource also tagged with the tag. Tags are often used in sharing media, social bookmarking, social news and blog entries to help users search for associated content. In some contexts, the term “tagging” as used herein refers to the process of associating a tag with a resource that can be tagged. As used herein, the term “tagged association” refers to an association that identifies a tag and a resource that is tagged with the tag. A resource is said to be “tagged” with a tag when a tagging process, also referred to as “tagging”, has successfully created a tagged association. In other contexts, a “tagging” refers to a tagged association.

The term “matched tag”, as used herein, refers to an association that identifies a tag and a tagging criterion, where the tagging criterion is based on data other than the tag. The tagging criterion may be based additionally on the tag. The term “tagging association”, as used herein, refers to a matched tag represented in a memory, either persistent and/or volatile. For example, a tagging association may be realized as a record that includes and/or identifies a tag and a tagging criterion. The terms “matched tag” and “tagging association” are used interchangeably. When the term “matched tag” refers to something other than its tagging association, it will be made clear. For example, a reference to matched tag presented in a user interface clearly identifies a UI element that identifies and/or otherwise represents and/or otherwise identifies a matched tag either realized or to be realized in a tagging association. A tagged association, defined above, may identify a matched tag and a resource that is tagged with the tag identified by the matched tag. Such an association is also referred to herein as a “matched tag association”. A resource may be tagged with a matched tag when a tagging criterion identified by the matched tag is met for the resource.

As user herein, the term “vocabulary” refers to a set of valid values that can be assigned to and/or included in a data element. With respect to a tag, a vocabulary defines valid tags. A vocabulary may be specified by one or more rules and/or by identifying one or more valid values directly and/or indirectly.

As used herein, the term “dictionary” refers a vocabulary wherein one or more terms in the vocabulary is assigned a definition. A “definition” as the term is used herein refers to information that identifies semantic information about a data value, such as at tag. Semantic information may include one or more of a textual description of a meaning of the term, an audio description, a visual description, and information identifying a use or context for the term. A use and/or context may be identified, for example, by identifying a part of speech, a dialect or language, an antonym, a synonym, and/or an example usage of the defined data value.

As used herein, any reference to an entity “in” an association is equivalent to describing the object as “identified” by the association, unless explicitly indicated otherwise.

As used herein, the term “communication” refers to information including a message sent and/or for sending via a network between communicants. A message may include text data, audio data, and/or image data. The term “communicant” as used herein refers to a user included in a communication as a sender and/or a receiver of the information. A communicant is represented by a “communications agent” configured to operate in an execution environment to send data to and/or receive data from another communications agent, on behalf of the represented communicant, according to a communications protocol via network. A communications protocol defines and/or otherwise identifies an address space including communications addresses for delivering data sent in a communication from one communications agent to another. A communications protocol is a type of network protocol.

The term “communicant alias” as used herein refers to an identifier of a communicant in a communication where the communicant alias is not a communications address included in an address space of a communications protocol for sending and/or receiving data in the communication.

The term “attachment” as used herein refers to a portion of a communication that includes data from one communicant to another other than data in the message portion. A resource sent as an attachment is data that is typically not presented “inline” or in a message included in a message portion of a communication. Email attachments are perhaps the most widely known attachments included in communications. An email attachment is a file or other resource sent along with an email in a portion of the email separate from a message portion. A communication may include one or more resources as one or more attachments.

The terms “contactor” and “contactee” identify roles in a communication. A “contactor” provides information for identifying a “contactee” in a communication. A contactee may be included in a communication by a contactor and/or the contactor's communications agent. A contactor and/or a contactee are roles of a user or communicant of a communications agent and may be a living being, a node, a component, and/or an application. Both a contactor and a contactee are communicants in a communication.

As used here, the term “tagging-attribute association” refers to an association that identifies one or more tagging criterion and a resource attribute that the one or more tagging criterion are each based on. That is, whether a tagging criterion identified in a tagging-attribute association is met for a specified resource depends on an attribute of the resource identified by the tagging-attribute association. The term attribute, as used herein, includes the resource, as a resource is considered to be an attribute of itself and/or otherwise to include at least some of its attributes.

As used herein, the term “resource scope” defines a set of resources from which resources may be identified from some purpose. For example, the files within a specified folder and its subfolders in a file system define and/or otherwise specify a resource scope. All user accounts that have an administrator security role define another resource scope. The present disclosure describes a resource scope with respect to resources tagged with a specified tag that makeup a set, referred to herein as a “tagged resource set”. A tagged resource set may include a resource tagged with a tag identified by a matched tag.

One or more criterion may be specified, in code and/or in configuration data, specifies and/or otherwise defines a resources scope. Such a criterion is referred to herein as a “scope criterion”. A scope criterion may be expressed via any suitable manner, such as a file name, a wildcard expression, a regular expression, a data store location, a data base query, geospatial coordinates, a time, a date, a duration, a relationship to a user, and an address—too name a few examples. With respect to a tag, a scope criterion included in defining a resource scope differs from a tagging criterion for the tag in that the scope criterion included in defining a resource scope need not be met in order for a resource to be tagged with the tag. Further a resource scope may be used for purposes other than processing related to a tagged resource.

One or more scope criterion that together specifies and/or otherwise define a resource scope is/are referred to herein as a “scope descriptor”. When all the criteria are met for a resource, the resource is in the resource scope defined by the scope descriptor. The one or more separate criterion in a scope descriptor may be evaluated in any order suitable or desirable in any given embodiment. In an aspect described below, one scope criterion, that may be included in a scope descriptor, may be specified to determine and/or otherwise identify when the scope descriptor is “active”. A scope criterion that indicates whether a scope descriptor is active is referred to herein as a “scope condition”. In a further aspect a scope descriptor may include no other criterion indicating the resource scope includes all resources accessible to an application, subsystem, execution environment, and/or group of any of the preceding that are processing and/or otherwise making use of the scope descriptor. Those skilled in the art will understand that whether a scope criterion in a scope descriptor is called a scope condition or not is a matter of choice. The terms are used herein to aid in describing the subject matter from a perspective that is not intended to limit the claimed subject matter.

Although, those skilled in the art will know that a scope criterion may be defined as “met” when it is true or may be defined as “met” when it is not true; for purposes of the present disclosure, a scope criterion in the role of a scope condition in a scope descriptor is said to be “met” when it indicates the scope descriptor is active, as is said to be “not met” otherwise. A scope criterion is set to be “met” for a resource when it indicates the resource is in the resource scope defined by the scope descriptor, and is to be “not met” otherwise. For example, when a scope condition is a scope descriptor is not met, a scope criterion in the scope descriptor, by definition is not met. In an aspect, a scope descriptor may not include a scope condition or may include a scope condition that is always met. Such a scope descriptor is active by definition. Whether a criterion, in a scope descriptor is met or is not met, may depend on an evaluation of the scope criterion that is based on an identifiable entity. For a scope condition, such an entity is referred to herein as a “condition entity”. For a scope criterion, such an entity is referred to herein as a “scoping entity”. Exemplary entities include a user, a document, a measure of time, a location, and the like. The terms “resource scope” and “scope descriptor” are used interchangeably herein.

An association between a tag and scope descriptor is referred to herein as a “scoped tag”. A scoped tag is also referred to herein as a match set. As defined above, a tagging criterion may be used to determine whether to tag a particular resource with a particular tag. The tagging criterion is associated with the tag by a matched tag. A scope descriptor identifies resource scope that includes a set of resources. Scope descriptors are necessarily associated with resources.

A “tagging context”, as the term is used herein, identifies and/or otherwise includes a set of tagged associations or taggings. The taggings may identify one or more tags and one or more resources. A “tagging context specification”, as the term is used herein, is data that defines and/or otherwise specifies a tagging context. A tagging context specification may be stored in a memory location. The memory location may be contiguous or not and may be included in one or more data storage media, which may be volatile or not. A tagging context specification may include and/or otherwise identify any suitable criterion for determining whether a tagging is in a tagging context defined by the tagging context specification. For example, a tag contact specification may identify one or more scope descriptors, one or more tags some or all of which may be and/or may be identified by matched tags, and a context condition.

A “context condition”, as the term is used herein, refers to a condition or criterion that when met indicates that a tagging context is active for one or more taggings. When a context condition is not met, it is said to be inactive or not active for one or more taggings. For example, a context condition in a tagging context specification may be met for a first user. Taggings in the tagging context are “active” for the first user. For a second user, the context condition may not be met. The taggings are not active for the second user. A context condition may be based on any suitable data for any suitable entity. A tagging context may be active for a task and not for another and/or a tagging context may be active for one location and not for another, to name a couple of other examples. When a context condition indicates that an associated tagging context is active for a tag, the context condition is herein said to be “met”, otherwise the context condition is not met.

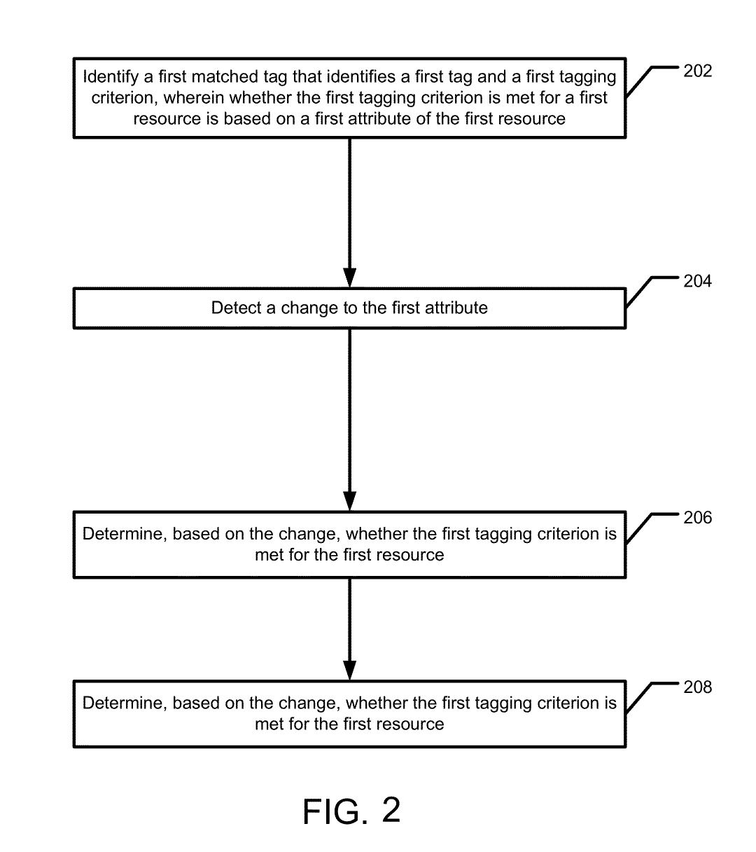

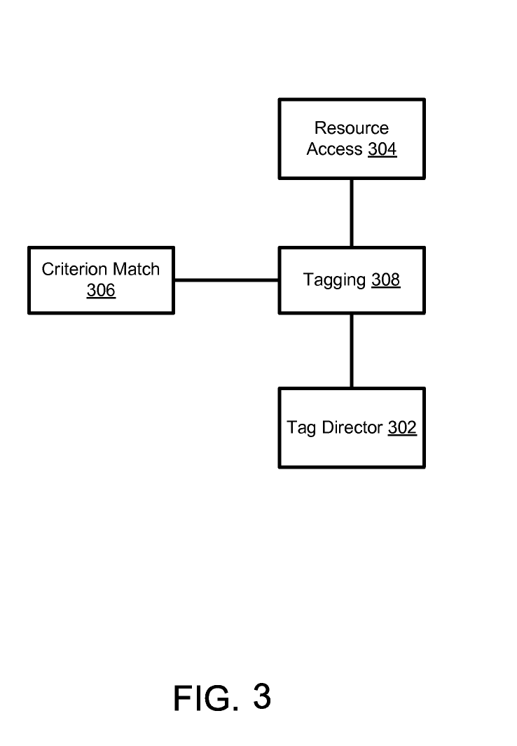

FIG. 3 illustrates an arrangement of components in a system that operates in an execution environment, such as execution environment 102 in FIG. 1. The arrangement of components in the system operates to perform the method illustrated in FIG. 2. The system illustrated includes a tag director component 302, a resource access component 304, a criterion match component 306, and a tagging component 308. A suitable execution environment includes a processor, such as processor 104, to process an instruction in at least one of a tag director component, a resource access component, a criterion match component, and a tagging component.

Some components, illustrated in the drawings are identified by numbers with an alphanumeric suffix. A component may be referred to generically in the singular or the plural by dropping a suffix oR a portion thereof of the component's identifier. For example, execution environments; such as execution environment 401a, execution environment 401b, execution environment 401c, execution environment 401d, and their adaptations and analogs; are referred to herein generically as an execution environment 401 or execution environments 401 when describing more than one. Other components identified with an alphanumeric suffix may be referred to generically or as a group in a similar manner.

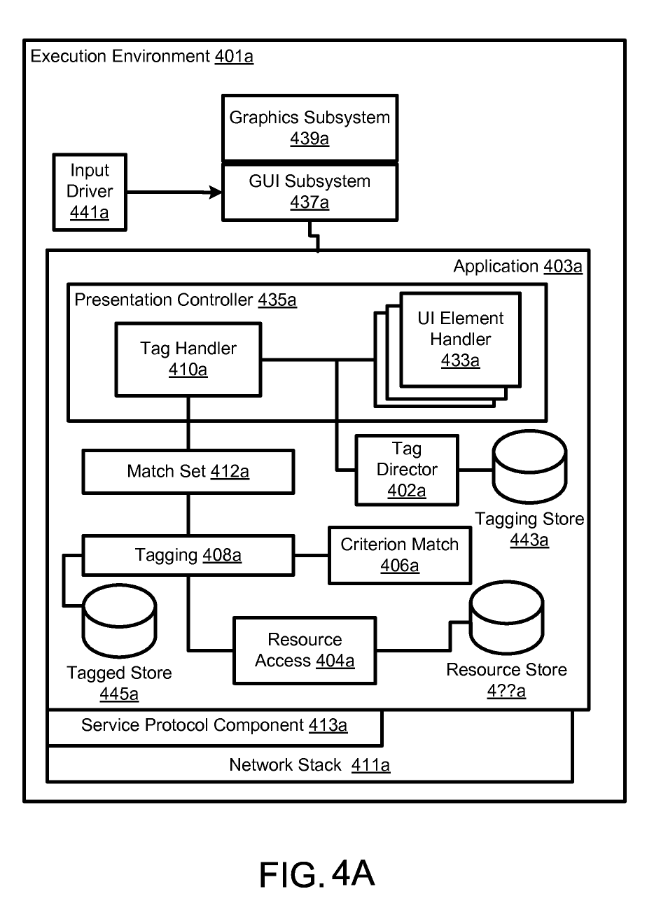

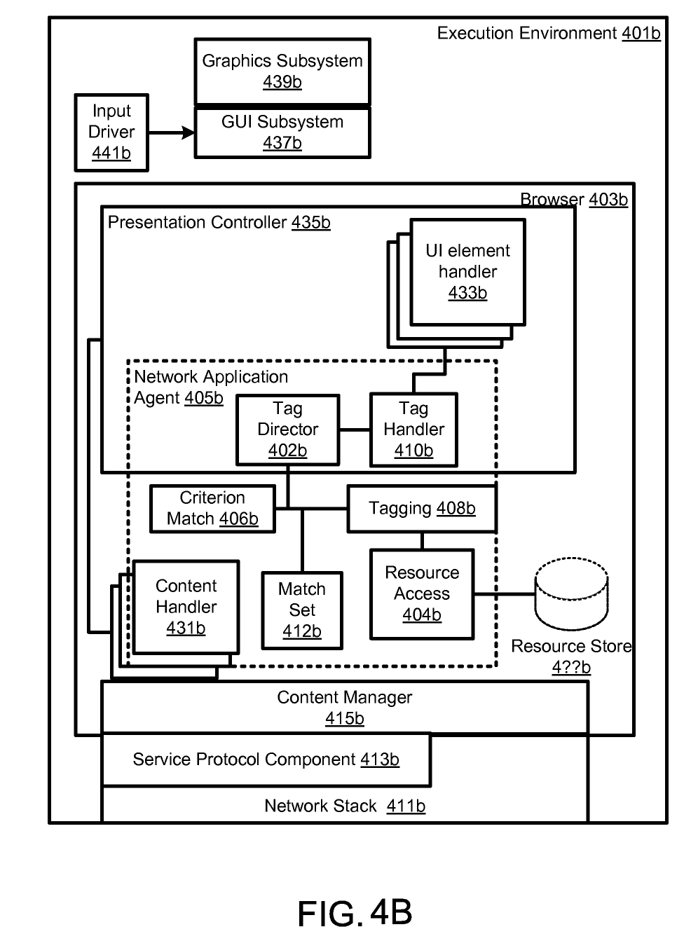

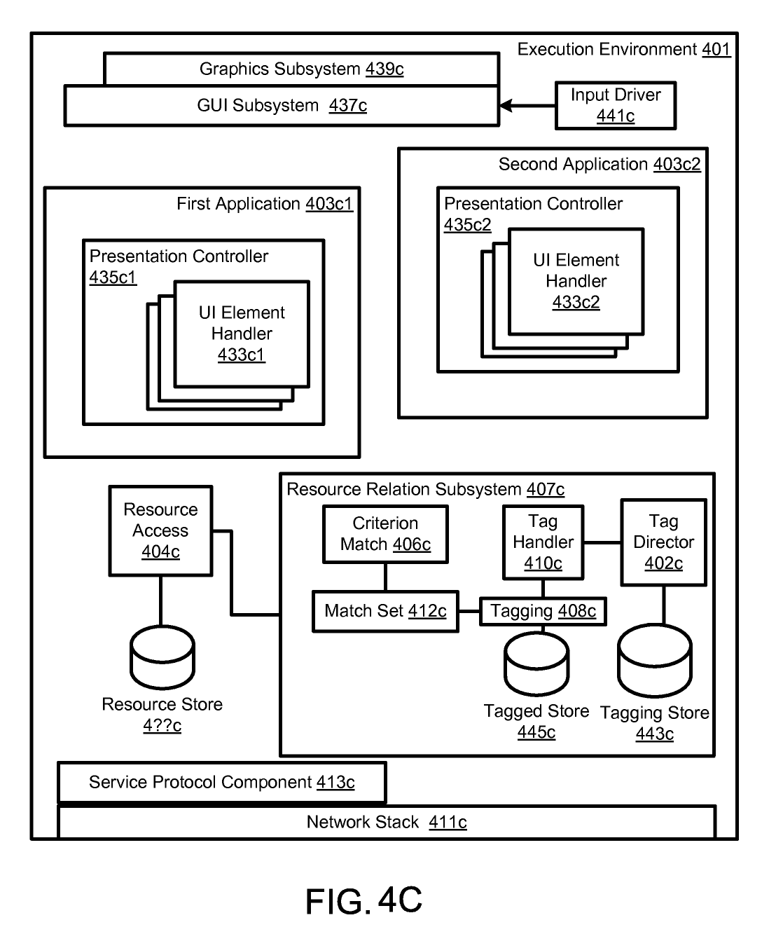

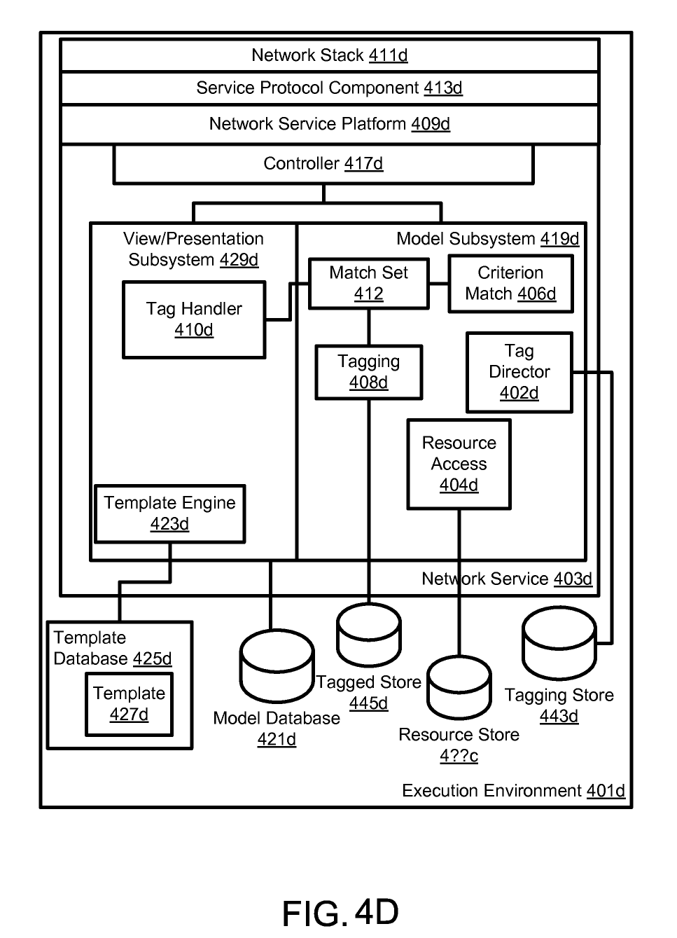

Some or all of the exemplary components illustrated in FIG. 3 may be adapted to operate in a number of execution environments to perform the method illustrated in FIG. 2. FIGS. 4A-D are each block diagrams illustrating the components of FIG. 3 and/or analogs of the components of FIG. 3 respectively adapted to operate in an execution environment 401a, an execution environment 401b, an execution environment 401c, and an execution environment 401d that each include and/or otherwise are provided by one or more nodes. FIG. 1 illustrates key components of an exemplary device that may at least partially provide and/or otherwise be included in an execution environment. The components illustrated in FIGS. 4A-D may be included in or otherwise combined with the components of FIG. 1 to create a variety of arrangements of components according to the subject matter described herein.

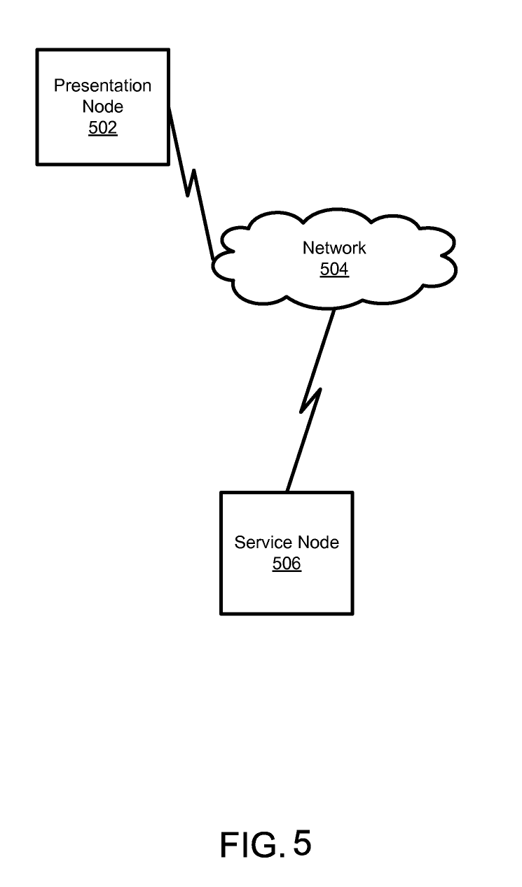

FIG. 5 illustrates a user node 502 as an exemplary device that in various aspects may be included in and/or otherwise adapted to provide any execution environment 401 illustrated in FIGS. 4A-C each illustrating a different adaptation of the arrangement of components in FIG. 3. In an aspect, a user node may be included in and/or otherwise host an execution environment 401d and/or an analog of execution environment 401d. As illustrated in FIG. 5, user node 502 is operatively coupled to a network 504 via a network interface component, such as network interface adapter 114. Alternatively or additionally, an adaptation of an execution environment 401 may include and/or may otherwise be provided by a device that is not operatively coupled to a network. A server device is illustrated by a service provider node 506. Service provider node 506 may be included in and/or otherwise provide execution environment 401d illustrated in FIG. 4D and/or an analog of execution environment 401d. In an aspect, a service provider node may be included in and/or otherwise host any execution environment 401 and/or an analog of any execution environment 401 illustrated in FIGS. 4A-C. As illustrated in FIG. 5, service provider node 506 is operatively coupled to network 504 via a network interface component included in execution environment 401d. Thus, service provider node 506 is communicatively coupled to one or more user nodes and/or other service provider nodes.

FIG. 4A illustrates that execution environment 401a hosts an application 403a that includes an adaptation of the arrangement of components in FIG. 3. FIG. 4B illustrates execution environment 401b hosting a browser 403b including an adaptation of the arrangement of components in FIG. 3 that may operate at least partially in a network application agent 405b received from a remote application provider, such as a network service 403d in FIG. 4D. Browser 403b and execution environment 401b may provide at least part of an execution environment for network application agent 405b that may be received via network 504 from network service 403d operating in service provider node 506. FIG. 4C illustrates an arrangement of the components in FIG. 3 adapted to operate at least partially in a tagging subsystem 407c of execution environment 401c.

FIG. 4D illustrates execution environment 401d hosting one or more network services, such as a web application, illustrated by network service 403d. FIG. 4D also illustrates a network service platform 409d that may provide services to one or more network services. Network service 403d includes yet another adaptation of the arrangement of components in FIG. 3.

As stated the various adaptations of the arrangement in FIG. 3 are not exhaustive. For example, those skilled in the art will see based on the description herein that arrangements of components for performing the method illustrated in FIG. 2 may operate in a single device, or may be distributed across more than one node in a network and/or more than one execution environment. For example, such an arrangement or arrangements may operate at least partially in browser 403b illustrated in FIG. 4B and at least partially in execution environment 401d in and/or external to network service 403d.

FIGS. 4A-D illustrate network stacks 411 that operate to send and receive data over network 504, via a network interface component. Network service platform 409d in FIG. 4D provides services to one or more network services. In various aspects, network service platform 409d may include and/or interoperate with a web server. FIG. 4D also illustrates network service platform 409d may interoperate with a network stack 411d.

Interoperating network stacks 411 may support the same protocol suite, such as TCP/IP, or may communicate via a network gateway or other protocol translation device and/or service. For example, browser 403b in FIG. 4B and network service platform 409d in FIG. 4D may interoperate via their respective network stacks: a network stack 411b and network stack 411d.

FIGS. 4A-D illustrate applications 403, respectively, which may communicate via one or more service protocols. FIGS. 4A-D respectively illustrate service protocol components 413 that operate to communicate via one or more service protocols. Exemplary service protocols include hypertext transfer protocol (HTTP), remote procedure call (RPC) protocols, instant messaging protocols, and presence protocols. Matching protocols enabling applications 403 to communicate via network 504 in FIG. 5 are not required, if communication is via a protocol gateway or other translator.

FIG. 4B illustrates that a browser may receive some or all of a network application agent in one or more messages sent from a network service, such as network service 403d, via a network service platform 409d, a network stack 411d, a network interface component, and optionally a service protocol component 413d. In FIG. 4B, browser 403b includes a content manager component 415b. Content manager component 415b may interoperate with one or more of service protocol components 413b and/or network stack 411b to receive the message or messages including some or all of a network application agent 405b.

A network application agent 405 may include a web page for presenting a user interface for and/or otherwise based on data from a corresponding network service. The web page may include and/or reference data represented in one or more formats including hypertext markup language (HTML) and/or other markup language, ECMAScript or other scripting language, byte code, image data, audio data, and/or machine code.

In an example, in response to a request received from browser 403b, a controller component 417d, in FIG. 4D, may invoke a model subsystem 419d to perform request-specific processing. Model subsystem 419d may include any number of request handlers (not shown) that operate to dynamically generate data and/or to retrieve data from a model database 421d based on the request. Controller component 417d may further invoke a template engine component 423d to identify one or more templates and/or static data elements to generate a user interface to present a response to the received request. FIG. 4D illustrates a template database 425d including an exemplary template 427d. FIG. 4D illustrates template engine component 425d as a component in a view subsystem 429d that operates to return responses to processed requests in a presentation format suitable for a client, such as browser 403b. View subsystem 429d may provide the presentation data to controller component 417d to send to browser 403b in response to the request received from browser 403b. Some or all of a network application agent may be sent to a browser via a network service platform, as described above.

While the example describes sending some or all of a network application agent in response to a request, network service 403d additionally or alternatively may send some or all of network application agent 405b to browser 403b via one or more asynchronous messages. In an aspect, an asynchronous message may be sent in response to a change detected by network service 403d. Publish-subscribe protocols, such as the presence protocol specified by XMPP-IM, are exemplary protocols for sending messages asynchronously.

The one or more messages including information representing some or all of network application agent 405b illustrated in FIG. 4B may be received by content manager component 415b via one or more of service protocol component(s) 413b and network stack 411b as described above. In FIG. 4B, browser 403b includes one or more content handler components 431b to process received data according to its data type, typically identified by a MIME-type identifier. Exemplary content handler components 431b include a text/html content handler component for processing HTML documents; an application/xmpp-xml content handler component for processing XMPP streams including presence tuples, instant messages, and publish-subscribe data as defined by various XMPP specifications; one or more video content handler components for processing video streams of various types; and still image data content handler components for processing various images types. Content handler components 431b process received data and may provide a representation of the processed data to one or more user interface (UI) element handler components 433b.

UI element handler components 433 are respectively illustrated in presentation controller components 435 in FIGS. 4A-C. A presentation controller component 435 may manage visual, audio, and/or other types of output of its including application 403 as well as receive and route detected user and other inputs to components and extensions of its including application 403. With respect to FIG. 4B, a UI element handler component 433b in various aspects may be adapted to operate at least partially in a content handler component 431b such as a text/html content handler component and/or a script content handler component. Additionally or alternatively, a UI element handler component 433 in an execution environment 401 may operate in and/or as an extension of its including application 403. For example, a plug-in may provide a virtual machine, for a UI element handler component 433 received as a script and/or byte code, that may operate as an extension in an application 403 and/or external to and interoperating with the application 403.

Various UI elements of applications 403 may be presented by one or more UI element handler components 433 in FIGS. 4A-C and/or by view subsystem 429d as illustrated in FIG. 4D. In an aspect, illustrated in FIGS. 4A-C, A UI element handler component 433 of one or more applications 403 may operate to send presentation information representing a UI element to a GUI subsystem 437. A GUI subsystem 437 may instruct a graphics subsystem 439 to draw the UI element in a region of a presentation space, based on representation information received from the corresponding UI element handler component 433.

User input may be received corresponding to a UI element via an input driver 441 illustrated in FIGS. 4A-C in various adaptations. For example, a user may move a mouse to move a pointer presented in a display presentation space over a UI element. A user may provide an input detected by the mouse. The detected input may be received by a GUI subsystem 437 via an input driver 441 as an operation or command indicator based on the association of the shared location of the pointer and the UI element in the display presentation space.

A matched tag may be created in response to user input. In various aspects a tag director component 402 may receive tagging information based on input information from a UI element handler component 433. In an aspect, a user input may be detected that corresponds to a UI element presented for identifying a tag. A tag may be a user entered tag and/or otherwise a user selected tag. Further, criterion information identifying a tagging criterion may be received via the same or different UI element handler component 433, where the tagging criterion is based on something other than and/or in addition to the identified tag. In another aspect, a tagging criterion may be determined based on a user identified tag, by a UI element handler component 433 and/or by a tag director component 402, in response to a user detected input identifying the tag. The tag director component 402 may create a “matched tag” by creating a tagging association that identifies the tag and the tagging criterion. The tag director component 402 may store the tagging association in any suitable memory locations, such a storage system illustrated by a tagging store 443. A tagging store may be included in and/or my include some or all of a database, a file system, a disk I/O system, and/or a structure in a processor memory, to name some examples.

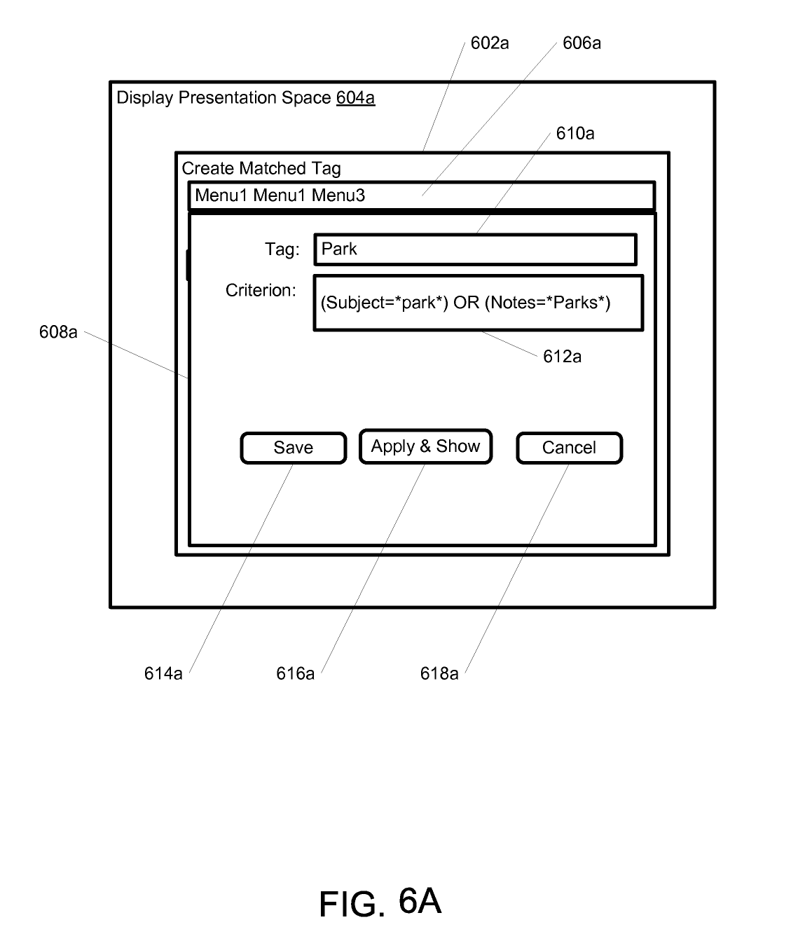

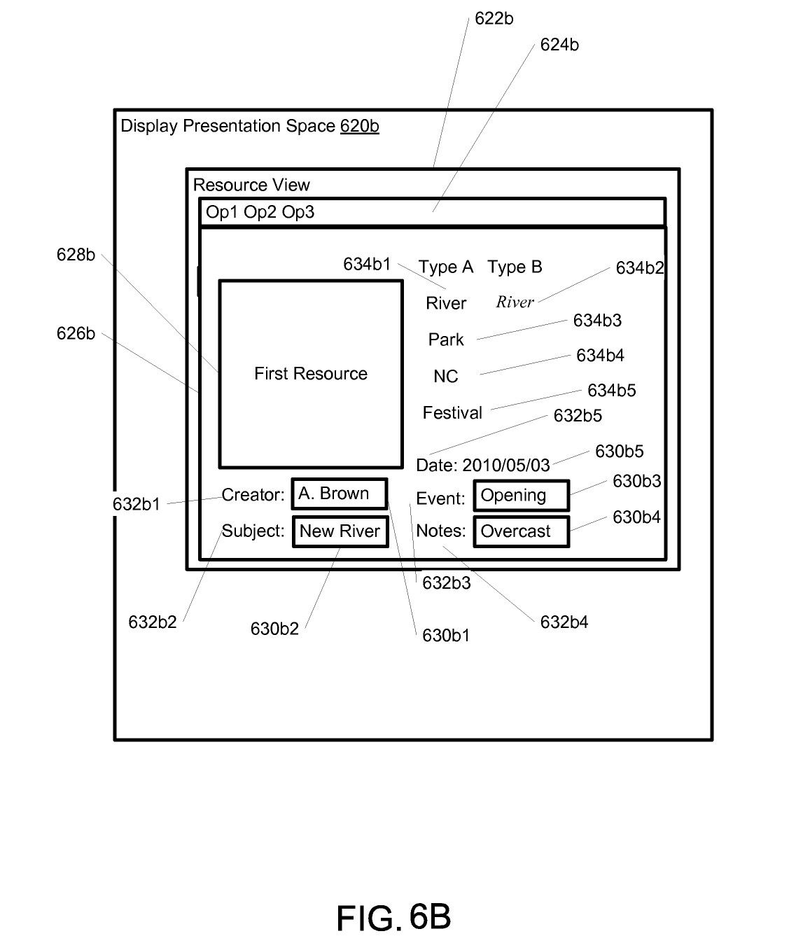

FIG. 6A depicts a user interface presented by an application 403 as described above for any of FIGS. 4A-D. The application 403 includes one or more UI element handlers 433 to present a create matched tag UI element 602a in a presentation space 604a of a display device. Create matched tag UI element 602a is illustrated with a menu bar UI element 606a including input UI elements for receiving user input for various specified operations. Create matched tag UI element 602a includes an input pane UI element 608a to prompt a user to provide corresponding input to provide tagging information via a tag input UI element 610a. In FIG. 6A, a criterion input UI element 612a is presented by a corresponding UI element handler component 433a allowing corresponding user input that identifies a tagging criterion to be received and/or otherwise detected. The criterion information identifying a tagging criterion is based on data other and/or in addition to the tag identified by the received tagging information.

FIG. 6A illustrates input information (Subject=*park*) OR (Notes=*Parks*) as criterion information provided by the user. An application 403 may operate to identify “Subject” as an identifier of a metadata attribute of a resource. In an aspect, the resource may include a digital photograph, a document, and/or streaming data. The application may identify a metadata attribute with an identifier “Notes” defined to contain and/or otherwise identify user provided notes about an associated resource. FIG. 6A also illustrates tagging information identifying “Park” as the user identified tag. The input information may be received by one or more UI element handler components 433 that may be included in and/or may otherwise include a tag handler component 410 that correspond to tag input UI element 610a and criterion input UI element 612a. A tag director component 402 may receive the tagging information and the criterion information in response to a user input targeting a “Save” UI element 614a and/or an “Apply & Show” UI element 616a. The user may cancel providing tagging information and criterion information by directing an input to a “Cancel” UI element 618a.

In an aspect, an operation may be performed to determine whether a tagging criterion is met for a resource, in response to detecting an access to the resource and/or otherwise identifying the resource. Detecting an access to and/or otherwise identifying a resource may be direct and/or indirect. Further detecting an access to and/or otherwise identifying a resource may include receiving an identifier of a resource, detecting an indication that a resource is to be accessed, detecting a resource while it is accessed, and/or detecting a resource subsequent to an access to the resource.

With respect to FIGS. 4A-D, an application 403 may access and/or otherwise identify an access to a resource, in response to a request to present a listing of resources in a folder in a file system, data base, and/or other data repository that includes the particular resource. A criterion match component 406 may be invoked, in response to accessing the resource and/or an identifier of the resource. A tag director component 402 may interoperate with the criterion match component 406 to identify a tagging criterion identified by a matched tag. The criterion match component 406 may determine whether the tagging criterion is met for the resource based on one or more attributes associated with the resource. The tagging criterion may be based on data associated with the resource other than and/or in addition to the tag. For example, the tagging criterion may specify a threshold criterion based on an attribute that identifies a playing duration of a video stream. An attribute may be determined, calculated, and/or otherwise identified as needed in an aspect. In another aspect, an attribute may be stored persistently in any suitable data storage medium. A criterion match component 406 may operate to access video stream play duration information from the metadata attribute in and/or otherwise associated with a video file in order to evaluate the tagging criterion. The criterion match component 406 may determine that the tagging criterion is met. This process may be repeated in response to accessing each resource in the identified data repository. A criterion match component 406 may detect that the tagging criterion is met for a plurality of resources. In the playing duration example, described above, the matched tag identifying the tagging criterion may identify the tag “movie” or “feature length”. When the threshold is exceeded, the tagging criterion may be specified to indicate the criterion is met when evaluated for a particular video file.

With respect to FIGS. 4A-D, a criterion match component 406 may determine that a tagging criterion is met for a resource. The criterion match component 406 may invoke, directly and/or indirectly, a tagging component 408 and identify the resource, the tag, and optionally the tagging criterion to the tagging component 408. The tagging component 408 may tag the resource by creating a tagged association that identifies the resource and the matched tag. The tagged association may be stored in any suitable memory location, as illustrated by a tagged store 445 in FIGS. 4A-D.

With reference to FIG. 2, a block 202 illustrates that the method includes identifying a first matched tag that identifies a first tag and a first tagging criterion, wherein whether the first tagging criterion is met for a first resource is based on a first attribute of the first resource. Accordingly, a system for automatically managing tagging of a resource includes means for identifying a first matched tag that identifies a first tag and a first tagging criterion, wherein whether the first tagging criterion is met for a first resource is based on a first attribute of the first resource. For example, the arrangement in FIG. 3, includes tag director component 302 that is operable for identifying a first matched tag that identifies a first tag and a first tagging criterion, wherein whether the first tagging criterion is met for a first resource is based on a first attribute of the first resource. FIGS. 4A-D illustrate tag director components 402 as adaptations and/or analogs of the tag director component 302 in FIG. 3. One or more tag director components 402 operate in an execution environment 401. The system for automatically managing tagging of a resource includes one or more processors and logic encoded in one or more tangible media for execution by the one or more processors that when executed is operable for identifying a first matched tag that identifies a first tag and a first tagging criterion, wherein whether the first tagging criterion is met for a first resource is based on a first attribute of the first resource.

In FIG. 4A, a tag director component 402a is illustrated as a component of application 403a. In FIG. 4B, a tag director component 402b is illustrated as a component of network application agent 405b. In FIG. 4C, a tag director component 402c is illustrated operating external to one or more applications 403c. Execution environment 401c includes a tag director component 402c in a tagging subsystem 407c. In FIG. 4D, a tag director component 402d is illustrated operating in network service 403d remote from a network agent communicatively coupled to the network service 403d. In an aspect tag director component 402b and tag director component 402d communicate via browser 403b and network service 403d in performing a portion of the method illustrated in FIG. 2 in block 202.

With respect to FIGS. 4A-D, a tag director component 402 may access and/or otherwise identify a matched tag in creating a tagging association and/or in accessing a tagging association from a memory location, such as a location in a tagging store 443. The tag director component 402 may determine that the matched tag identifies a tag and a tagging criterion. An attribute for a resource may be included in the resource and/or otherwise may be associated with the resource as, for example metadata for the resource.

An application 403 in an execution environment 401 may invoke a tag director component 402 accessible via the execution environment 401. The tag director component 402 may create, delete, modify, maintain, and otherwise access tagging associations that represent respective matched tags in a tagging store 443. One or more tags may each be included in one or more matched tags. Each matched tag identifies a tagging criterion. The tagging criterion is met for particular resource based on an attribute of the resource. The tagging criterion identifies the attribute.

In an aspect, in FIG. 4A, tag director component 402a may determine and/or identify a matched tag that identifies a tagging criterion. The tagging criterion may be based on an attribute of a specified resource and/or resource category. Tag director component 402a may process tagging associations in tagging store 443a, to locate and/or otherwise identify the matched tag based the attribute. Tag director component 402a may operate to identify a matched tag, its identified tagging criterion, and/or an attribute of a resource upon which a tagging criterion is based. Tag director component 402a may identify the matched tag in response to resource access component 404a detecting an access to and/or otherwise identifying a resource including and/or otherwise having the attribute. The resource may already be tagged and/or may be available for tagging.

Alternatively or additionally, a tag director component 402 may operate to create, delete, and/or otherwise maintain one or more tagging-attribute associations, defined above. In FIG. 4B, a tag director component 402b may store a tagging-attribute association in a memory location, which may be volatile, and/or in a memory location that may be persistent. Tag director component 402b may operate in an execution environment 401b of a user node 502 to communicate via network 504 with a network service 403d, in FIG. 4D, in an execution environment 401d of a service provide 506 to store a tagging-attribute association in a location in a tagged store 445d, a tagging store 443d, a resource store 447d, and/or any other storage accessible to execution environment 401d. Tag director component 402b, in FIG. 4B, may interoperate with tag director component 402d to create, delete, update, and/or otherwise maintain a tagging-attribute association.

With respect to FIG. 4A-D, in another aspect, a tag director component 402 may interoperate with a tagging component 408 to dynamically tag a resource, in response to accessing and/or otherwise identifying the resource. In FIG. 4C, at the direction of tagging component 408c, tag director component 402c may retrieve and/or identify a first tagging criterion in a first matched tag. The first tagging criterion may be provided to and/or otherwise may be identified to criterion match component 406c, by tag director component 402c and/or by tagging component 408b. Criterion match component 406c may determine that the first tagging criterion is met for the resource. In response, tagging component 408c may operate to tag the resource with the first matched tag that includes the first tagging criterion. The first resource may be similarly tagged with a second matched tag in response to criterion match component 406c determining that a second tagging criterion, identified by the second matched tag, is met. The first matched tag and the second matched tag may each identify an identical first tag.

With respect to FIG. 4A-D, a tag director component 402 may create and otherwise receive a matched tag and may store a tagging association in any suitable way and at any suitable time. Alternatively or additionally, when a resource attribute is changed by and/or on behalf of an application 403, tag director component 402 may identify one or more tagging-attribute associations to identify one or matched tags that each identify a tagging criterion based on the attribute. In FIG. 4C, a change to a resource attribute may be detected by interoperating with a resource access component 404c that operates to retrieve, delete, store, and/or otherwise maintain an attribute for a specified resource. A change to a resource attribute may be detected by a UI element handler 433 in response to a user input that is processed to change the attribute.

A resource attribute may be included in a resource and/or associated with the resource as, for example metadata for the resource. In FIG. 4D, tagging component 408d may operate, in response to detecting a change in an attribute of a resource, such as an owner attribute, to determine, via interoperation with tag director component 402d to identify a tagging criterion, that is based on the attribute.

Other exemplary attributes for a resource include an owner, a user with a particular access right, an access right, an operation that includes processing the resource, a content type or MIME type, creation time, access time, modified time, a lock or semaphore state for accessing the resource, a geospatial location of the resource, a demographic attribute of a user of the resource, a duration associated with the resource, a measure of accesses, a size, a measure of user interaction, an attribute of a device and/or hardware component that represents and/or operates on the resource, a group, a legal entity, a rule, a policy, a law, a practice, a stage in a multi-stage process, an attribute of an account, an attribute of some or all of the content of the resource, a tag, a measure of power, a measure of utilization, an ambient condition, a measure of attention, a measure of interaction, a program component for performing some or all of an operation based the resource, an attribute of a communication that identifies the resource, a presence status, an attribute of data storage system that includes a representation of some or all of the resource.

Returning to FIG. 2, a block 204 illustrates that the method further includes detecting a change to the first attribute. Accordingly, a system for automatically managing tagging of a resource includes means for detecting a change to the first attribute. For example, the arrangement in FIG. 3, includes resource access component 304 that is operable for detecting a change to the first attribute. FIGS. 4A-D illustrate resource access components 404 as adaptations and/or analogs of resource access component 304 in FIG. 3. One or more resource access components 404 operate in an execution environment 401. The system for automatically managing tagging of a resource includes one or more processors and logic encoded in one or more tangible media for execution by the one or more processors that when executed is operable for detecting a change to the first attribute.

In FIG. 4A, a resource access component 404a is illustrated as a component of application 403a. In FIG. 4B, a resource access component 404b is illustrated as a component of network application agent 405b. In FIG. 4C, a resource access component 404c is illustrated operating external to one or more applications 403c. Execution environment 401c includes a resource access component 404c in tagging subsystem 407c. In FIG. 4D, a resource access component 404d is illustrated operating in network service 403d remote from a network agent communicatively coupled to the network service 403d. In an aspect resource access component 404b and resource access component 406d communicate via browser 403b and network service 403d in performing a portion of the method illustrated in FIG. 2 in block 204.

In an aspect, an attribute of a resource may change in response to user input. FIG. 6B illustrates a presentation space 620b of a display device. With respect to FIGS. 4A-D, an application 403 operating in an execution environment 401 may present a resource view UI element 622b via operation of one or more UI element handler components 433. The application 403 may interoperate with a GUI subsystem 437 via a network and/or locally to present resource view UI element 622b and any other UI elements it may include. A UI element handler 433b may provide a menu bar UI element 624b including UI elements representing actions and/or operations that may be invoked via a detected a corresponding user input. The same or a different UI element handler component 433 may present a pane UI element 626b in which resource related UI elements may be presented. FIG. 6B illustrates a first resource UI element 628b representing a first resource that may be currently tagged, is being tagged, and/or will be tagged during its presentation. The first resource may include an image, such as the first image of fruit, such as green pear.

A resource access component 404 may access and/or otherwise identify one or more attributes of the first resource presented in first resource UI element 628b. Resource access component 404 may provide attribute information identifying the one or more attributes to one or more UI element handler components 433. The UI element handler components 433b may send presentation information to present, to a user, attribute UI elements 630b to represent a value for each of the one or more identified attributes for the first resource. In FIG. 6B, identifier UI elements 632b may be presented to identify, to the user, each of the represented attributes. FIG. 6B, illustrates a first identifier UI element 632b1 identifying a “Creator” of the first resource identified by a first attribute UI element 630b1 as “A. Brown”. A second identifier UI element 632b2 identifying a “Subject” of the first resource identified by a second attribute UI element 630b2 as “New River”. A third identifier UI element 632b3 identifying an “Event” associated with the first resource identified by a third attribute UI element 630b3 as “Opening”. A fourth identifier UI element 632b4 identifying “Notes” provided for the first resource identified by a fourth attribute UI element 630b4 as “Park”. A fifth identifier UI element 632b identifying a “Date” of the first resource identified by a fifth attribute UI element 630b2 as “2010/05/03”. Values for the first through the fourth attributes are presented as input UI elements. Inputs corresponding to any of attribute UI elements 630b1-4 may be processed by a corresponding UI element handler 433 to change a value for a corresponding attribute for the first resource. Attribute UI element 630b5 is presented so that inputs corresponding to attribute UI element 630b5 are not processed to change the value of the corresponding date attribute.

A tagging component 408 may identify matched tags and/or tags for the first resource. A tag director component 402 may access tagging associations specifying and/or otherwise defining respective matched tags. Application 403 may invoke a tag handler component 410 for the various matched tags and/or tags identified by tagging component 408. The one or more tag handler component(s) 410 may operate to send presentation information to present, along with first resource UI element 628b that represents the first resource, tag user interface elements 634b. A first tag 634b1 may be identified in a first matched tag that identifies a first tagging criterion that is met or not based on a value assigned to one or both of the subject attribute represented by the second attribute UI element 630b2 and the notes attribute represented by the notes attribute UI element 630b4. Other tags 634b may be identified by respective matched tags that identify tagging criterion that are each met for the first resource.

In FIG. 4A, a request to present a resource may be detected by a UI element handler component 433a of application 403a. Application 403a may access, the resource, in responding to the user request. The UI element handler component 433a may operate to present the resource in a resource UI element. The UI element handler component 433a corresponding to the resource UI element may include and/or otherwise interoperate with tagging component 408a as described above to identify one or more matched tags for the resource. For a matched tag that tags the resource, application 403a may invoke a tag handler component 410a to generate presentation information for the matched tag. The tag handler component(s) 410a may send the presentation information to present, via an output device along with the resource UI element, a tag UI element that represents the tag with which the first resource is tagged.

In any of execution environments 401 in FIGS. 4A-D, a UI element component 433 may be invoked, in response to a user input that targets and/or that otherwise corresponds to an attribute UI element 630b in FIG. 6B. The UI element component 433 may determine which attribute UI element 630b corresponds to the detected user input. When first attribute UI element 630b1 corresponds to the user input, a corresponding UI element component 433, in an aspect, may maintain and/or otherwise access data that associates the first attribute UI element 630b1 and/or the corresponding input directly and/or indirectly to the Creator attribute for the first resource. Analogously, when second attribute UI element 630b corresponds to the user input, the same and/or different UI element handler component 433 may maintain and/or otherwise access data that associates the second attribute UI element 630b2 and/or the corresponding input directly and/or indirectly to the Subject attribute for the first resource. Input corresponding to other editable attribute UI elements 630b may be processed similarly.

As described above, a UI element handler component 433 may detect a change to an attribute for a resource, in response to a detected user input for changing the attribute. Additionally, a resource access component 404 may operate, in response to the change detected by the UI element handler component 433 to change the value of the attribute and/or otherwise to detect the change to the attribute. In FIG. 6B, a user input corresponding to the Subject attribute UI element 630b2 may be detected by a UI element handler component 433. The user input may remove “New River” and replace it with “Rapids”. The UI element handler component 433 may send presentation information to update second attribute UI element 630b to replace “New River” with “Rapids”. Resource access component 404 may be invoked to detect the change to the Subject attribute for the first resource. In an aspect, resource access component 404 may locate a storage location for the attribute and store a representation of “Rapids: in the location to replace a representation of “New River”.

In FIG. 2, a block 206 illustrates that the method yet further includes determining, based on the change, whether the first tagging criterion is met for the first resource. Accordingly, a system for automatically managing tagging of a resource includes means for determining, based on the change, whether the first tagging criterion is met for the first resource. For example, the arrangement in FIG. 3, includes criterion match component 306 that is operable for determining, based on the change, whether the first tagging criterion is met for the first resource. FIGS. 4A-D illustrate criterion match components 406 as adaptations and/or analogs of criterion match component 304 in FIG. 3. One or more criterion match components 406 operate in an execution environment 401. The system for automatically managing tagging of a resource includes one or more processors and logic encoded in one or more tangible media for execution by the one or more processors that when executed is operable for determining, based on the change, whether the first tagging criterion is met for the first resource

In FIG. 4A, a criterion match component 406a is illustrated as a component of application 403a. In FIG. 4B, a criterion match component 406b is illustrated as a component of network application agent 405b. In FIG. 4C, a criterion match component 402c is illustrated operating external to one or more applications 403c. Execution environment 401c includes a criterion match component 406c in tagging subsystem 407c. In FIG. 4D, a criterion match component 406d is illustrated operating in network service 403d remote from a network agent communicatively coupled to the network service 403d. In an aspect criterion match component 406b and criterion match component 406d communicate via browser 403b and network service 403d in performing a portion of the method illustrated in FIG. 2 in block 206.

When a change to a resource for an attribute is detected, a matched tag that identifies a tagging criterion based on the attribute may be located. Whether the criterion is met or not is based on the attribute. When the change is detected the resource may be tagged with the matched tag or not tagged with the matched tag. In an aspect, a tag director component 402 may look up and/or otherwise identify one or more matched tags that identify respective tagging criteria each based on the attribute. The tag director component 402 may interoperate with tagging store 443 to identify the one or more matched tags In an aspect, a tag director component 402 may locate and/or otherwise identify a matched tag identifying a tagging criterion based on the attribute by locating a tagging-attribute association that identifies the attribute and the matched tag.

In FIG. 4b and FIG. 4d, criterion match component 406d and/or a criterion match component 406b which may be included in a network agent 403b communicatively coupled to network service 403d via a network, may determine whether a tagging criterion based on specified attribute is met or is no longer met for the resource, as a result detecting a change to the attribute.

In another aspect, a change may be detected to an attribute of the first resource represented by resource UI element 628b in FIG. 6B. For example, the change to the Subject attribute represented by attribute UI element 630b2 described above. The change may be detected by the resource access component 404 and/or the UI element handler component 433 that processes input information targeting attribute UI element 630b2. The change may be detected after tag UI elements 634b have been presented in view pane UI element 626b. The tag UI elements 634b each represent a tag and/or a matched tag that tags the first resource represented by resource UI element 628b. Each matched tag identifies a tagging criterion that is met for the first resource. For, example, a third tagging criterion identified by a third matched tag represented in FIG. 6B by tag UI element 634b3 may depend on the Subject attribute and/or the Notes attribute. Further, a first tagging criterion identified by a first matched tag represented by first tag UI element 634b1 may be based on the Subject attribute and the Notes attribute. A fourth tagging criterion identified by a fourth matched tag represented by fourth tag UI element 634b4 may be based on the Subject attribute and an address and/or other location based attribute for the create attribute not represented in resource view UI element 622b. A second tagging criterion identified by a second matched tag may be based on a geospatial attribute that identifies the location of the image included in the first resource. The second tagging criterion may identify one or more locations of certain rivers. The second tagging criterion may be met when the location attribute of the image is determined to identify a location at least partially included in a location identified by the second tagging criterion.

In the example, whether the second tagging criterion is met for the first resource is based on the second attribute. The second tagging criterion may be met for the first resource when the Subject attribute and/or the Notes attribute includes the string “Park” or “National Forest”. In response to detecting the change of the Subject attribute to “Rapids”, a criterion match component 406 may receive information via the tag director component 402 identifying the second tagging criterion and may receive information via the resource access component 404 identifying the change to the Subject attribute. Criterion match component 406 may determine and/or otherwise detect whether the second tagging criterion is met or not met for the first resource based on the change to the Subject attribute. Changes to other attributes may be processed similarly. As described, when the Subject attribute is changed to “Rapids”, the second tagging criterion is not met. The first resource may not be tagged by a sixth matched tag identifying a sixth tagging criterion based on the Subject attribute and identifying the tag, “White water”. Tag director component 402 may identify the sixth tag, in response to the change in the Subject resource based on a tagging-attribute association that identifies the Subject attribute and the sixth matched tag. Criterion match component 406, interoperating with tag director component 402 and resource access component 404, may operate to determine whether the sixth tagging criterion is met, based on the change. The criterion match component 406 may determine that the sixth tagging criterion is met based on the change of the Subject attribute to “Rapids”.

As described in an example above, measures of temperature may be received and/or otherwise identified by a resource access component 404. The received information may also identify a location, which may identify one or more devices as resources. A change in temperature as measured for a location may change whether a tagging criterion based on a measure of temperature is met or not for a device identified based on the location. For example, one or more measures of temperature may be communicated to a resource access component 404, operating in an execution environment 401. The resource access component interoperating with a tag director component 402 may identify a tagging criterion, identified by a matched tag, that is based on a temperature attribute. The device identified by the location may have such an attribute associated with it. The tagging criterion and the attribute for the device may be provided to and/or otherwise made accessible to a criterion match component 406 for evaluating whether the tagging criterion, identified by a matched tag, is met or is not met. The tagging criterion may be met based on whether a measure of heat is within a range and/or otherwise meets a threshold condition. The tagging director component 402 may receive and/or otherwise identify a tag associated with the tagging criterion by a tagging association.

More specifically, a tagging director component 402 may identify a number of matched tags respectively identifying tagging criterion based on various metrics for measuring temperature. Each matched tag identifies a respective tag. The tags identified may include, for example, “Normal”, “Alert”, and “Warning”, each identified by a matched tag with a respective tagging criterion. Such tags may be used by an application or system that monitors one or more devices which may be located at various locations. Temperature information from the one or more locations may be communicated to a node including and/or otherwise included in an execution environment 401. A criterion match component 406 may be invoked in response to receiving temperature information. Tagging criteria identified by one or more matched tags may also be based on location, changed attributes upon which the tagging criteria are dependent, and/or other information. In response to receiving temperature information for a location, the criterion match component 406 may locate any resources representing the electronic devices and/or locations to determine whether tagging criterion identified respectively by the one or more of the matched tags is met or is no longer met. In response, to determining that that a tagging criterion is met or no longer met for a resource, in response to receiving temperature and/or humidity information.

Returning to FIG. 2, a block 208 illustrates that the method yet further includes tagging the first resource with the first tag, automatically in response to determining that the first criterion is met. Accordingly, a system for automatically managing tagging of a resource includes means for tagging the first resource with the first tag, automatically in response to determining that the first criterion is met. For example, the arrangement in FIG. 3, includes tagging component 308 that is operable for tagging the first resource with the first tag, automatically in response to determining that the first criterion is met. FIGS. 4A-D illustrate tagging components 408 as adaptations and/or analogs of tagging component 308 in FIG. 3. One or more tagging components 408 operate in an execution environment 401. The system for automatically managing tagging of a resource includes one or more processors and logic encoded in one or more tangible media for execution by the one or more processors that when executed is operable for tagging the first resource with the first tag, automatically in response to determining that the first criterion is met.

A block 210, in FIG. 2, illustrates that the method yet further includes removing a tagging of the first resource with the first tag, automatically in response determining that the first tagging criterion is not met. Accordingly, a system for automatically managing tagging of a resource includes means for removing a tagging of the first resource with the first tag, automatically in response determining that the first tagging criterion is not met. For example, the arrangement in FIG. 3, includes tagging component 308 that is operable for removing a tagging of the first resource with the first tag, automatically in response determining that the first tagging criterion is not met. FIGS. 4A-D illustrate tagging components 408 as adaptations and/or analogs of tagging component 308 in FIG. 3. One or more tagging components 408 operate in an execution environment 401. The system for automatically managing tagging of a resource includes one or more processors and logic encoded in one or more tangible media for execution by the one or more processors that when executed is operable for removing a tagging of the first resource with the first tag, automatically in response determining that the first tagging criterion is not met.

In FIG. 4A, a tagging component 408a is illustrated as a component of application 403a. In FIG. 4B, a tagging component 408b is illustrated as a component of network application agent 405b. In FIG. 4C, a tagging component 408c is illustrated operating external to one or more applications 403c. Execution environment 401c includes a tagging component 408c in tagging subsystem 407c. In FIG. 4D, a tagging component 406d is illustrated operating in network service 403d remote from a network agent communicatively coupled to the network service 403d. In an aspect tagging component 408b and tagging component 408d communicate via browser 403b and network service 403d in performing a portion of the method illustrated in FIG. 2 in block 208 and in block 210.

In response to a change in the attribute, the resource may be tagged with the tag, remain tag with the tag, the tag may be removed as a tag for the resource, or the resource may remain untagged by the tag. As described above a change to an attribute for a resource may change whether a tagging criterion, based on the attribute, is met or not for the resource. Returning to the example describing a temperature attribute for a device, The criterion match component 406 may operate to determine whether the tagging criterion based on a temperature attribute for the device is met or is not met, in response to new temperature information. As described above, one or more tagging criterion identified by respective matched tag may be met based the temperature attribute of the device. The matches tags may respectively identify the tags “Normal”, “Alert”, and “Warning”. In response, to determining that a tagging criterion, identified by a first matched tag identifying the tag “Alert”, is no longer met for the resource, a tagging component 408 may be invoked to untag and/or to tag the resource with respect to the first matched tag. In response, to determining that that a tagging criterion, identified by a second matched tag identifying the tag “Normal”, is met, tagging component 408 may be invoked to tag the device with the first matched tag.

In response, to determining that that a tagging criterion is met or no longer met for a resource, a tagging component 408 may be invoked to untag and/or to tag the resource Further, a user interface presenting a resource UI element representing a resource and tag UI elements representing tags for the resource may change in response to a change to an attribute for the resource. A tag UI element change may include being presented, removed, or modified; based on a change in an attribute associated with a resource. As described, the change may change whether a tagging criterion based on the attribute is met or not for the resource.

Returning again to the temperature attribute example, when the first tagging criterion is determined to no be met for the device in response to the change in the temperature attribute, a tagging component 408 may be invoked to untag the first matched tag from the device and a tag handler component 410 for a tag UI element representing the “Alert” tag identified by the first matched tag may be removed from a user interface. In response, to determining that the second tagging criterion is met, tagging component 408 may be invoked to tag the device with the second matched tag and a tag handler component 410 may send presentation information to present a tag UI element representing the “Normal” tag identified by the second matched tag.

Note that a user viewing a representation of a monitored device and/or a location may direct input to a tag for the resource to locate other resources with the tag. With respect to FIGS. 4A-D, a user may see via a display that a resource tagged with the tag, “Normal” is untagged with respect to the “Normal” tag and may see an “Alert” tag represented, in response to the resource being tagged with the “Alert” tag. User input may be detected corresponding to a tag UI element representing, for example, “Alert’. A corresponding tag handler component 408 may operate to instruct a match set component 412 to locate one or more other resources tagged with the “Alert” matched tag.

In an aspect, in response to a change in an attribute for a resource, a tag UI element may be automatically presented, a tag UI element may be automatically removed from a presentation, and/or a tag UI element may automatically be modified in a manner that is user detectable.

In a further aspect, a change to a second attribute for second resource may change a first attribute for a first resource. For example, a presence status attribute for a user may change a user interaction attribute for an application, device, an image, to name a few examples. In an aspect, the first attribute may be based on whether the second resource is tagged with a particular tag and/or matched tag. Thus, tagging and/or untagging a second resource with one or more matched tags may effect whether the first resource is tagged with an associated matched tag. Further, a tag UI element for a first resource may be changed in response to a change to an attribute of the second resource. The change may be automatic.

When a tagging criterion for a resource is met, the resource may be tagged or may remained tagged, when included in an existing tagging, with the matched tag that identifies the tagging criterion. When a criterion match component 406 determines that a tagging criterion is not met, the resource may remain without a tagging that includes the matched tag. A tagging component 408 may determine whether the resource is tagged with the matched tag. When the tagging component 408 determines the resource is tagged with the matched tag, the tagging component 408 may delete and/or otherwise remove the tagging for the matched tag with respect to the resource. The tagging component 408 may delete the tagging by deleting a tagged association that identifies the matched tag and the resource. In another aspect, a tagging component 408 may determine that a resource is not tagged with a particular matched tag. A newly created attribute and a deleted attribute are considered, herein, to be changes to attributes. In response to a change in an attribute of a resource, the tagging component may tag the resource with the matched tag. More than one matched tagged may identify the same and/or equivalent tag. The tagging component 408 may further delete a tagged association for another matched tag that identifies the same tag, so that the resource may not be tagged by more than one matched tag that identifies the same tag.

Presentation information may be sent to indicate that the a resource is no longer tagged with a particular matched tag. A tag handler component 410 may send presentation information to remove a tag UI element representing the tag from a presentation space of an output device Removing the tag UI element may be one indication that may be defined to inform a user that the resource is no longer tagged with the matched tag. Alternatively or additionally, presentation information may be sent to present a user detectable change to the tag UI element defined to indicate to the user that the resource is not tagged with the matched tag. The tag UI element may be modified in a manner defined to inform a user that the resource is no longer tagged with the matched tag. For example, the tag UI element may be greyed and disabled as an input UI element. Alternatively or additionally, an action may be associated with the tag UI element that is invoked in response to an input corresponding to the tag UI element. The action may present an indication, such as sound or text message, defined to indicate that the resource is no longer tagged with the matched tag. After a specified period or in response to a specified event, presentation information may be sent to remove the tag UI element from the presentation space.

In an aspect, a tagged association may be stored in a processor memory for a duration of a particular task, such as the presentation of the resource and the tag. When the presentation ends, the tagged association may be deleted and/or otherwise destroyed by a tagging component 408. When the resource is accessed again, a criterion match component 406 may be invoked again to determine whether the tagging criterion is met for the resource. If the data that the tagging criterion is based on has changed, the tagging criterion might not be met, for the resource. If the tagging criterion is met, criterion match component 406 may again invoke tagging component 408 to once again tag the resource and, thus, detect that the resource is tagged with the matched tag.

In another aspect, detecting that a resource is tagged with a matched tag may be performed by tagging component 408 automatically in response to the creation of a matched tag, by tag director component 402, as described above. Thus, tagging may be performed automatically in response to identifying that a tagging criterion in the matched tag is met for a resource.

In any of execution environments 401 in FIGS. 4A-D, a tag handler component 410 may be invoked, in response to a user input that targets and/or that otherwise corresponds to a tag UI element 634b in FIG. 6B that represents a tag identified in a particular matched tag. The tag handler component 410 may determine which tag UI element 634b corresponds to the detected user input. When first tag UI element 634b1 corresponds to the user input, a first tag handler component 410, in an aspect, may maintain and/or otherwise access data that associates the first tag UI element 634b1 and/or the corresponding input directly and/or indirectly to the first matched tag. Analogously, when second tag UI element 634b2 corresponds to the user input, a second tag handler component 410 may maintain and/or otherwise access data that associates the second tag UI element 634b2 and/or the corresponding input directly and/or indirectly to the second matched tag. Input corresponding to other tag UI elements 634b may be processed similarly.

A tag handler component 410 may correspond to all of tag UI elements 634b. When first tag UI element 634b1 corresponds to a detected user input, tag handler component 410 and/or a GUI subsystem 437 may maintain and/or otherwise access data that associates the first tag UI element 634b1 and/or the corresponding input directly and/or indirectly to the first matched tag. Analogously, when second tag UI element 634b2 corresponds to the user input, tag handler component 410 and/or GUI subsystem 437 may maintain and/or otherwise access data that associates the second tag UI element 634b2 and/or the corresponding input directly and/or indirectly to the second matched tag. Input corresponding to other tag UI elements 634b may be processed similarly.

As described above, a tag handler component 410 may be invoked, in response to a user input that targets and/or that otherwise corresponds to a tag UI element, representing a first matched tag, presented by the tag handler component 410. The tag handler component 410 may process information received in response to the user input as selection information and may identify a particular matched tag also represented by the tag UI element. A match set component 412 may, based on identification of the matched tag by the tag handler component 410, lookup and/or otherwise identify resources tagged with the tag where the tagging criterion, identified by the particular matched tag, is met for each of the resources. Selection information that identifies a first tag in a tagged association identifying a first resource and a first matched tag, associates the first tag with a first tagging criterion. A match set component 412 operates, based on the selection information, to identify resources, tagged with the first matched tag, for which the first tagging criterion is met. Such resources define a resource set.

The methods illustrated in FIG. 2 may include additional aspects supported by various adaptations and/or analogs of the arrangement of components in FIG. 3.

Exemplary resources that may be tagged include documents and other text data, image data including pictures and video, audio data, form data, streaming data, user accounts, representations of user groups, legal entities, executable entities, hardware components, a network and/or Web based services, and a computer resources such as disks, threads, memory, and the like.

Identifying a matched tag that identifies a tag and a tagging criterion may include accessing a tagging association that identifies the tag and the tagging criterion. Accessing the tagging association may include creating, deleting, updating, and/or receiving data from the tagging association. The tagging criterion includes an identifier of an attribute and/or attribute type for a resource. With respect to FIGS. 4A-D, a tag director component 402 operates to access one or more tagging associations.

A matched tag may be identified in response to detecting a change in an attribute, of a resource, that is included in determining whether a tagging criterion identified by the match tag is met for the resource. The change may be detected in response to a user input for changing the attribute. Identifying a matched tag may include identifying an attribute, identifying a tagging criterion based on the attribute, and identifying the matched tag based on the tagging criterion. Identifying a matched tag may include identifying a tagging-attribute association, based on the attribute. The tagging-attribute association identifies the matched tag. With respect to FIGS. 4A-D, a tag director component 402 may receive information identifying an attribute. The tag director component 402 may search for tagging criterion that are based on the tag. The tag director component 402 may access one or more tagging associations in performing the search. The search identifies a matching tagging criterion. The tag director component 402 may identify one or more tagging associations, that represent respective matched tags, that identify the tagging criterion. In another aspect, a tag director component 402 may perform a lookup based on an identified attribute of one or more tagging-attribute associations to identify a matched tag based on the attribute.

A matched tag may be identified in response to a detected access to a resource tagged with the matched tag. Detecting the access may include detecting an access to an attribute of the resource. A matched tag may be identified by and/or in response to detecting a user input corresponding to a UI element, presented by an output device, that represents the matched tag.

An attribute for a resource may be stored in a location in a volatile memory. An attribute may be stored in a memory location in a persistent memory. An attribute for a resource may be relatively persistent and/or volatile. The attention of students, machine operators, and/or customers may be highly variable based a particular metric for determining measures of attention and/or based on how often measurements are determined. An attribute may be defined so that it is relatively persistent by determining a value for the attribute just once, infrequently, and/or by determining the attribute's value based on a long-term metric such as a moving average over months or years. Similar status and/or time base attributes may be specified for particular resources and/or categories of resources. Such attributes include ranking attributes such as measures of popularity and/or satisfaction, lab data for human health, presence data such as presence status, and the like. Another example of a types of attributes for various resource and/or resource types that may be persistent and/or volatile are attributes based on geospatial location. Some resources, such as buildings, don't move while other resource, such as automobiles, move. It should be apparent given the description herein to those skilled in the art that an attribute for a resource may be based on a metric and/or a measure for one or more of a time, a date, and a duration.

An attribute for a resource may include information that identifies an owner, a user with a particular access right, an access right, an operation that includes processing the resource, a content type or MIME type, a creation time, an access time, a modified time, a lock or semaphore state for accessing the resource, a geospatial location of the resource, a demographic attribute of a user of the resource, a duration associated with the resource, a measure of accesses, a size, an attribute of a hardware component that represents and/or operates on the resource, a group, a legal entity, a rule, a policy, a law, a practice, a stage in a multi-stage process, an attribute of an account, an attribute of some or all of the content of the resource, a tag, a measure of power, a measure of utilization, an ambient condition, a measure of attention, a measure of interaction, a program component that performs some or all of an operation based the first resource, an attribute of a communication that identifies the first resource, a presence status, and/or an attribute of data storage system that includes a representation of some or all of the resource.

Detecting a change to an attribute for a resource may include detecting a user input corresponding to an attribute UI element, presented by an output device, that represents the attribute, and changing the first attribute based on the user input.

Detecting a change to an attribute for a resource may include detecting an access to the attribute. The access may include one or more of retrieving data included in the attribute, creating the attribute, deleting the attribute, disabling an association between the attribute and the resource, modifying the attribute, and moving the attribute from one memory location to another memory location. Detecting the access may include detecting an access to a current value included in the attribute that is different than a corresponding previous value previously included in the attribute. With respect to FIGS. 4A-D, a resource access component 404 may detect an access to a resource which may be and/or may include an access to an attribute of the resource.

Detecting the change to a first attribute may include detecting a change to a second attribute for the first resource and/or for a second resource. The change to the first attribute is detected based on detecting the change to the second attribute. The first attribute may be changed in response to detecting the change to the second attribute.

Detecting a change to an attribute of a resource may include receiving data from a monitoring device monitoring a condition associated with first resource. An attribute for a resource such as an automobile, television, and/or other interactive device may be based on a measure of attention and/or a measure of interaction for the user. Various metrics and measures of user interaction and/or the lack of user interaction may be associated with a resource, such as device the user is or is not interacting with. A resource access component may receive and/or otherwise detect changes to attention and/or interaction attributes associated with the resource, such as the device. Attention and/or interaction attributes may be associated with the user which may be maintained and processed as a resource, in an aspect.

A criterion match component may determine whether a tagging criterion is met by comparing data identified in the tagging criterion and data included in an attribute included in determining whether the tagging criterion is met. A criterion match component may determine whether a tagging criterion is met by evaluating at least one of a Boolean expression, a specified policy, a regular expression, a natural language expression, a mathematical expression, a data base query language expression, a conditional expression, a filtering expression, a function, and a string expression.

In an aspect, a first matched tag may be included in a plurality of matched tags that respectively identify tags that respectively identify conditions associated with a first resource. In a further aspect, two or more tags may not be allowed to tag a resource at the same time. A tagging component may enforce such a rule and/or policy.

A criterion match component may determine that tagging criterion is met for a resource in response to an access to the resource by a hardware and optionally by a software component. A resource access component may detect an access to a resource in response to a user input detected via an input device. The access may be detected by detecting the user input via a tag handler component and/or a UI element handler component. The user input may target and/or otherwise correspond to a UI element presented for accessing and/or for presenting a representation of a resource that may be tagged with a tag for which the tagging criterion is determined.

Determining that a tagging criterion is met may include performing a search operation by a match set component and receiving a result identifying a set of matching resources. The search may be based on a tagging criterion. A criterion match component may operate with a match set component to perform a search operation, provide for performing a search operation, and/or receive results of a search operation via interaction, direct and/or indirect, with a search engine. Alternatively, a separate determination may be made for each resource identified in the result to identify any resources for which the tagging criterion is met.

In response to a change to an attribute for a resource, determining whether a tagging criterion, based on the attribute, is met for the resource may occur at the time the change is detected in response to detecting the change. Alternatively or additionally, a determination based on the change may be made when an access to a resource is detected. Still further, such a determination may be made when a resource is created and/or otherwise initially identified. In yet another aspect, such a determination may be made at scheduled times, and/or in response to various detected conditions and events. For example, a determination may be performed in response to a user input event defined to initiate the determination.

In tagging a resource with a matched tag, a tagging component may first determine that the resource is not currently tagged with the matched tag.

As described above a first matched tag may be included in a plurality of tags. Tagging a resource with the first tag in response to a change in an attribute of the resource may include removing a tagging of the resource by a second tag in the plurality, based on a rule that two or more tags in the plurality may not tag the first resource at a time.

In response to detecting a change in an attribute that results in a tagging criterion being met for a resource, a tag hander component may send presentation information to present a tag UI element, via an output device and presented along with a resource UI element representing the resource, to represent the tag as a tag for the resource. The presentation information may be sent automatically in response to detecting the change. In an aspect, the tag may be a first tag included in a plurality of tags. Removing the tagging of a resource with the first tag may include sending second presentation information to remove a second tag UI element that represents a second matched tag in the plurality, based on a rule that two or more tags in the plurality may not be represented as tags for the first resource at a time

Removing a tagging of a tag for a resource may include sending first presentation information to modify a tag UI element, via an output device and presented along with a resource UI element representing the resource, that represents the tag to indicate to a user that the resource is not tagged with the tag. The tag UI element may be modified so that it is not detectable to the user as a result of the modifying. The tag UI element may be modified by removing the tag UI element from a presentation space of the output device. The tag UI element may be modified to indicate that an operation previously performed in response to an input targeting the tag UI element is disabled for the tag UI element.

Tagging a resource with a matched tag and/or removing a tagging of the matched tag for the resource may be performed automatically in response to detecting a change to an attribute that determines whether a tagging criterion identified by the matched tag is met for the resource.

A matched tag may be created in response to detecting user input identifying at least one the first tag and the first tagging criterion. A matched tag may be created while no resource is tagged with the matched tag. Alternatively or additionally, the match tag may be created while no resource allowed to be tagged with the matched tag is represented by an resource UI element by an output device.

A resource for which a tagging criterion, identified by a matched tag, is met, may be tagged by creating a tagged association that identifies tag and the resource. A tagged association may be stored in a storage location, wherein the storage location may be included in at least one of a volatile data storage medium and a non-volatile data storage medium.

A resource may be tagged with a tag identified by a matched tag automatically in response to the determining that the tagging criterion, identified by the matched tag, is met for the resource. Tagging a resource may be performed automatically in response to creating a matched tag.

A resource may be tagged automatically in response to detecting and/or otherwise identifying the resource. A resource may be detected directly and/or indirectly. In one aspect, a resource is detected indirectly in response to receiving and/or determining an identifier for the resource. Alternatively or additionally, a resource may be detected by detecting, directly and/or indirectly, an access to the resource. The resource may be accessed by a hardware component for processing based on an instruction executed by a processor. A resource may be detected by detecting an access for presenting a representation of the resource to a user via an output device. Detecting the access may include detecting an input corresponding to a UI element that includes a representation of at least one of the tag and the resource. A resource may be detected in a search result set. A search operation that produces a result set may be based on a tag in a matched tag and/or may be based on a tagging criterion in the matched tag.

A resource may be tagged with a tag by creating a tagged association that identifies the tag and the resource. The tag may be identified by identifying a matched tag that identifies the tag. A tagged association may identify a tag by including and/or otherwise identifying tagging information. A tagged association may identify a tagging criterion by including and/or otherwise identifying criterion information. A tagged association may be stored in a memory location which may be contiguous or not with respect to a physical storage medium and/or with respect to a virtual memory or logical storage system, such as file system or database. A memory location including a tagging association may be volatile, persistent, may be split between volatile and persistent memory, and/or may be replicated in one or more volatile and/or persistent memory locations.

Performing the method illustrated in FIG. 2 and/or any of its extension and/or in any of its aspects may include one or more of calling a function or method of an object, sending a message via a network; sending a message via an inter-process communication mechanism such as a pipe, a semaphore, a shared data area, and/or a queue; and/or receiving a request such as poll and responding to invoke, and sending an asynchronous message.

Output devices suitable for presenting a representation of a resource, an attribute, and/or a tag include a visual output device, an audio output device, and a tactile output device. One output device may present a resource and another output device may present a tag with which the resource is tagged.

As described the method may be performed by a non-networked device, a networked device, and/or may be performed may more than one device, and/or by more than one executable environment. Performing the method may include sending and/or receiving a message via a network. Further, a message, included in performing any of the subject matter described herein and/or any of its extensions in any of its aspects, may an asynchronous message without a corresponding request.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable storage medium for use by or in connection with an instruction execution machine, system, apparatus, or device, such as a computer-based or processor-containing machine, system, apparatus, or device. As used here, a “non-transitory computer readable storage medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable storage medium and execute the instructions for carrying out the described methods. A non-transitory computer readable storage medium is non-transitory. A non-exhaustive list of conventional exemplary non-transitory computer readable storage media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for automatically managing tagging of a resource, the method comprising:
identifying a first matched tag that identifies a first tag and a first tagging criterion, wherein whether the first tagging criterion is met for a first resource is based on a first attribute of the first resource;
detecting a change to the first attribute;
determining, based on the change, whether the first tagging criterion is met for the first resource; and
tagging the first resource with the first tag, automatically in response to determining that the first criterion is met,
wherein performing at least one of the preceding actions comprising the method includes execution of an instruction by a processor.

2. The method of claim 1 wherein identifying the first matched tag includes:
identifying the first attribute; and
identifying the first tagging criterion based on the first attribute.

3. The method of claim 1 wherein the first attribute identifies for the first resource at least one of an owner, a user with a particular access right, an access right, an operation that includes processing the first resource, a content type, a creation time, a an access time, a modified time, a lock for accessing the first resource, a geospatial location of the first resource, a demographic attribute of a user of the first resource, a duration associated with the first resource, a measure of accesses, a size, a measure of user interaction, a group, a legal entity, a rule, a policy, a law, a practice, a stage in a multi-stage process, an attribute of an account, an attribute of some or all of the content of the first resource, a tag, a measure of power, a measure of utilization, an ambient condition, a measure of attention, a measure of interaction, a program component for performing some or all of an operation based the first resource, an attribute of a communication that identifies the first resource, a presence status, and an attribute of a data storage system that includes a representation of some or all of the first resource.

4. The method of claim 1 wherein the first resource includes at least one of text data, image data, audio data, form data, streaming data, a user, a group, a legal entity, an executable program component, a hardware component, a service, and a process.

5. The method of claim 1 detecting the change to the first attribute includes receiving data from a monitoring device monitoring a condition associated with the first resource.

6. The method of claim 1 wherein determining whether the first tagging criterion is met includes evaluating at least one of a Boolean expression, a specified policy, a regular expression, a natural language expression, a mathematical expression, a data base query language expression, a conditional expression, a filtering expression, a function, and a string expression.

7. The method of claim 1 wherein the first matched tag is included in a plurality of matched tags that respectively identify tags that respectively identify conditions associated with the first resource.

8. The method of claim 7 wherein no two tags in the plurality are allowed to tag the first resource at a same time.

9. The method of claim 1 where determining the tagging criterion is met for the first resource includes:
detecting an access to the first resource; and
determining, in response to the access, that the tagging criterion is met for the first resource.

10. The method of claim 9 wherein the access is in response to an user input detected via an input device.

11. The method of claim 1 wherein determining that the tagging criterion is met for the first resource includes receiving, from a search operation based on the tagging criterion, a result identifying the first resource.

12. The method of claim 1 wherein tagging the first resource includes determining that the first resource not tagged with first tag.

13. The method of claim 12 wherein the tagging includes creating a first tagged association that identifies the first matched tag and the first resource

14. The method of claim 1 wherein the first tag is included in a plurality of tags and tagging the first resource with the first tag includes removing a tagging of the first resource by a second tag in the plurality, based on a rule that two or more tags in the plurality may not tag the first resource at a time.

15. The method of claim 1 further includes sending first presentation information to present a first tag UI element, via an output device and presented along with a resource UI element representing the first resource, to represent the first tag as a tag for the first resource.

16. The method of claim 15 wherein the first tag is included in a plurality of tags and removing the tagging of the first resource with the first tag includes sending second presentation information to present a second tag UI element that represents a second matched tag in the plurality, based on a rule that two or more tags in the plurality may not be represented as tags for the first resource at a time.

17. The method of claim 1 further includes sending first presentation information to modify a first tag UI element, via an output device and presented along with a resource UI element representing the first resource, that represents the first tag to indicate to a user that the first resource is not tagged with the first tag, wherein the first tag UI element is at least one of modified so that it is not detectable to the user as a result of the modifying, modified by removing the tag UI element from a presentation space of the output device, and modified to indicate that an operation previously performed in response to an input targeting the first tag UI element is disabled for the first tag UI element.

18. The method of claim 1 wherein the tagging is performed automatically in response to detecting the change.

19. A system for automatically managing tagging of a resource, the system comprising:
a tag director component or identifying a first matched tag that identifies a first tag and a first tagging criterion, wherein whether the first tagging criterion is met for a first resource is based on a first attribute of the first resource;
a resource access component for detecting a change to the first attribute;
an criterion match component for determining, based on the change, whether the first tagging criterion is met for the first resource; and
a tagging component for tagging the first resource with the first tag, automatically in response to determining that the first criterion is met,
a processor, wherein at least one of the tag director component, the resource access component, the criterion match component, and the tagging component includes an instruction that is executed by the processor during operation of the system.

20. A non-transitory computer readable storage medium embodying a computer program, executable by a machine, for automatically managing tagging of a resource, the computer program comprising executable instructions for:
identifying a first matched tag that identifies a first tag and a first tagging criterion, wherein whether the first tagging criterion is met for a first resource is based on a first attribute of the first resource;
detecting a change to the first attribute;
determining, based on the change, whether the first tagging criterion is met for the first resource; and
tagging the first resource with the first tag, automatically in response to determining that the first criterion is met.
